(19) United States
(12) Patent Application Publication
(10) Pub. No.: US 2010/0163805 A1
(43) Pub. Date: Jul. 1, 2010

(54) Agent-containing media and methods therefor

(76) Inventor: Youngtack Shim, Port Moody (CA)

Correspondence Address: Youngtack Shim, 155 Aspenwood Drive, Port Moody, BC, V3H 5A5, CA

(21) Appl. No.: 12/318,537

(22) Filed: Dec. 31, 2008

(51) Int. Cl. C09K 15/06; C09K 15/00; C09K 15/08; C09K 15/20

(52) U.S. Cl. 252/400.62; 252/397; 252/404; 252/403; 252/407

(57) ABSTRACT

The present invention generally relates to various media for protecting antioxidants contained therein from degradation before use. More particularly, the present invention relates to media which are to be dissolved in a fluid before use and to protect antioxidants contained therein from ultraviolet rays and from degradation caused by a prolonged period of dissolution in the fluid. To this end, such media include various fillers to protect the antioxidants from the ultraviolet rays. The present invention also relates to various media capable of promoting mixing of the antioxidants in the fluid. The present invention also relates to various methods of protecting such antioxidants contained in the media from such rays and various methods of promoting mixing between the fluid and antioxidants and/or fillers. The present invention further relates to various processes for providing various media protecting the antioxidants contained therein, various processes for fabricating such media capable of promoting the dissolution of the antioxidants and/or fillers into the fluid, and the like.

### CROSS-REFERENCES TO RELATED APPLICATIONS

The present application claims an earlier invention date of the Disclosure Document entitled the same, deposited in the U.S. Patent and Trademark Office (the “Office”) on Jan. 3, 2007 under the Disclosure Document Deposit Program (the “DDDP”) of the Office, and which bears the Ser. No. 610,798 an entire portion of which is incorporated herein by reference.

### FIELD OF THE INVENTION

The present invention generally relates to various media for protecting antioxidants contained therein from degradation before use. More particularly, the present invention relates to media which are to be dissolved in a fluid before use and to protect antioxidants contained therein from ultraviolet rays and from degradation caused by a prolonged period of dissolution in the fluid. To this end, such media include various fillers to protect the antioxidants from the ultraviolet rays. The present invention also relates to various media capable of promoting mixing of the antioxidants in the fluid. The present invention also relates to various methods of protecting such antioxidants contained in the media from such rays and various methods of promoting mixing between the fluid and antioxidants and/or fillers. The present invention further relates to various processes for providing various media protecting the antioxidants contained therein, various processes for fabricating such media capable of promoting the dissolution of the antioxidants and/or fillers into the fluid, and the like.

### BACKGROUND OF THE INVENTION

It is now well established in the medical community that oxidation reactions are the main culprit of aging in human beings. Every single cell inside the human body is continuously attacked by various oxidizing substances which may be intrinsic as well as extrinsic in their origin. Such substances may be huge molecules capable of inducing the oxidation reactions. However, the most powerful oxidizing substances are “reactive oxygen species” which are rather small molecules such as, e.g., hydrogen peroxides (H₂O₂), superoxide anions (O₂⁻), and free radicals including hydroxyl radicals (OH⁻). These species are so oxidative that any cells attacked thereby are degraded and unable to perform normal functions.

In order to obviate health hazards caused by these strong oxidizing substances, people are recommended to take various antioxidants capable of neutralizing such substances and, accordingly, preventing the oxidation reactions or at least reducing rates of such reactions. The most well-known antioxidant is the ascorbic acid or vitamin C, while other antioxidants also include various natural and synthetic substances, where such antioxidants are generally provided as pills, tablets or powder.

In progress with environmental pollution and a gradual loss of suitable sources, water is now sold in bottles under various names of spring water, mineral water, distilled water, just to name a few. Such bottled water is sometimes replenished with nutrients such as minerals, with flavors of various fruits, and the like. However, it is rare, if not impossible, to find such bottled water which contains the antioxidant. One reason is that numerous, if not all, antioxidants become unstable and degrade when irradiated by ultraviolet rays (to be abbreviated as the “UV rays” hereinafter). Thus, the antioxidants contained in the bottled water tend to be degraded and to lose their chemical and/or medical potency, long before use. In addition, some antioxidants tend to be degraded not bu such UV rays but solely by a long period of hydration. Accordingly, such antioxidants may lose their potency in proportion to the period of time during which they are dissolved in water.

Accordingly, there is a need for a proper medium for the antioxidant which is to be dissolved in the bottled water immediately before actual use, thereby minimizing an exposure of the antioxidants to the UV rays. There also is a need for such a medium to be stored inside and/or adjacent to the bottled water while isolating the medium from the water before use. There further is a need for the medium capable of promoting dissolution of the antioxidant into water immediately before use.

### SUMMARY OF THE INVENTION

The present invention generally relates to various media for protecting antioxidants contained therein from degradation before use. More particularly, the present invention relates to media which are to be dissolved in a fluid before use and to protect antioxidants contained therein from ultraviolet rays (to be referred to as the “UV rays” hereinafter) and/or from degradation caused by a prolonged period of dissolution in the fluid. To this end, such media are provided with various fillers capable of being mixed with the antioxidants and protecting the antioxidants from the UV rays before mixing with the fluid, capable of isolating such antioxidants from the fluid, and the like. The present invention also relates to various media capable of promoting dissolution of the antioxidants into the fluid when such media are immersed into the fluid. More particularly, the antioxidant and/or a mixture thereof with one or more fillers may form suitable structures promoting dissolution of the antioxidant into the fluid, may form pores therein for promoting flow of the fluid into various portions of the media, and the like. The present invention also relates to various media containing the fillers capable of generating gas when mixed with the fluid so that the gas bubbles move the media in the fluid and that the fluid adjacent to such media is mixed the antioxidant, thereby promoting mixing between the antioxidant and fluid.

The present invention relates to various methods of protecting the antioxidants contained in the media from the UV rays and prolonged period of dissolution into the fluid. To these ends, the present invention relates to various methods of disposing the antioxidant in the media in suitable arrangements, various methods of forming the media capable of isolating or segregating the antioxidant from the fluid before use, various methods of forming the media while providing paths of the fluid to the antioxidants which is disposed in the media, and the like. The present invention also relates to various methods of promoting mixing between the fluid and antioxidants and/or fillers and, therefore, dissolution thereof in the fluid. More particularly, the present invention relates to various methods of providing such media with various pores along which the antioxidant is distributed and in which the fluid flows in, various methods of forming the path for the fluid while the antioxidant or filler dissolves into the fluid, various methods of promoting such mixing by generating gas and moving the medium and/or fluid therearound, various methods of maintaining positions of the media in the fluid during the dissolution, and the like.

The present invention also relates to various processes for providing various media protecting the antioxidants contained therein from the UV rays and prolonged period of dissolution into the fluid. More particularly, the present invention relates to various processes for providing various media with structures for isolating the antioxidant from such UV rays, various processes for forming pores inside the media and segregating the antioxidant therealong, various processes for disposing the antioxidant and/or filler in and on the media, and the like. The present invention also relates to various processes for providing the media capable of promoting the mixing and dissolution of the antioxidant into the fluid. More particularly, the present invention relates to various processes for providing the media capable of forming the path for the fluid to flow into an interior of the media, capable of maintaining its position in the fluid during such dissolution, capable of alleviating resistances to molecular and/or convective mass transfer by generating movement of such media and/or fluid, capable of visualizing an extent of the dissolution by various means, and the like.

Therefore, a primary objective of the present invention is to provide a medium which includes at least one agent therein, protects the agent from adverse conditions, and then allows the agent to be mixed with a fluid only upon consumption. Therefore, a related objective of the present invention is to provide the medium including the agent which tends to be degraded by the UV rays, by a prolonged period of dissolution in the fluid, by forming precipitates during dissolution, and so on. Another related objective of this invention is to provide the medium with antioxidants, nutrients, medicine, herbs, and/or pharmaceuticals and to protect such from the above adverse conditions. Another related objective of this invention is to provide such a medium with at least one filler capable of protecting such an agent by forming coat layers, by producing gas during the dissolution, by supporting and retaining the agent, and the like. Another related objective of this invention is to provide the medium with the filler capable of promoting mixing between the agent and fluid.

Another objective of the present invention is to provide a medium which includes the agent and protect such before dissolution thereof into the fluid. Therefore, a related objective of this invention is to provide such a medium an entire portion of which is to dissolve into the fluid before use. Another related objective of this invention is to provide such a medium only a portion of which is to dissolve in the fluid, while the remaining portion serves to maintain a structure of the medium, to define the paths for the fluid during the dissolution, and the like. Another related objective of this invention is to include in the medium at least one filler an entire portion of which is to dissolve into the fluid or only a portion of which is to dissolve in the fluid.

Another objective of the present invention is to provide a medium which includes the agent and at least one optional filler capable of protecting the antioxidant and also promoting mixing between the fluid and antioxidant. Therefore, a related objective of this invention is to provide the medium with the filler capable of guarding against the UV rays. Another related objective of this invention is to provide the filler for inducing diffusive and/or convective mixing between the antioxidant and fluid by various means. Another related objective of this invention is to provide the filler capable of forming the path for the fluid before, during, and/or after the dissolution of the antioxidant and/or filler. Another related objective of this invention is to provide the filler capable of dissolving into the fluid with the antioxidant or being left behind after the dissolution of the antioxidant.

Another objective of the present invention is to provide a medium which includes the agent and at least one filler disposed to form one or multiple layers of coat around the antioxidant. Accordingly, a related objective of this invention is to provide the filler for protecting the antioxidants against the UV rays when formed into such layers. Another related objective of this invention is to provide the filler which dissolves into the fluid when immersed thereinto, thereby protecting the antioxidant before the dissolution but not during the dissolution.

Another objective of the present invention is to provide a medium which includes the agent and at least one filler capable of generating gas when mixed with the fluid. Therefore, a related objective of this invention is to distribute the filler in such an arrangement that the medium moves in the fluid by gas bubbles produced by the filler. Another related objective of this invention is to distribute the filler in another arrangement that the gas bubbles moves the fluid disposed adjacent to the medium, thereby reducing a concentration boundary layer which would otherwise be formed around such a medium. Another related objective of this invention is to provide the medium with the filler capable of forming the path for the fluid during or after generating the gas. Another related objective of this invention is to provide the medium with the filler which helps the medium maintain a specific position in the fluid by the gas produced thereby. Another related objective of this invention is to distribute such a filler in an even (or uneven) arrangement and/or in a symmetric (or asymmetric) arrangement such that the gas bubbles moves and/or orients the medium in the fluid during the dissolution. Another related objective of this invention is to provide the medium with the filler capable of producing CO₂ gas when mixed with the fluid and, therefore, carbonating the fluid.

Another objective of the present invention is to provide a medium which includes the agent and at least one filler capable of promoting mixing between the agent and fluid. Thus, a related objective of this invention is to fabricate a light medium capable of floating in the fluid during such dissolution of the antioxidant into the fluid. Another related objective of this invention is to fabricate a heavy medium capable of sinking into the fluid during dissolution of the antioxidant. Another related objective of this invention is to dispose the antioxidant and filler to ensure even or uniform dissolution of the antioxidant across the medium. Another related objective of this invention is to distribute the antioxidant and filler to ensure rapid dissolution of the antioxidant across such a medium. Another related objective of this invention is to provide the medium with a surface structure facilitating the mixing of the antioxidant and agent and, thus, enhancing the dissolution of the antioxidant into the fluid. Another related objective of this invention is to shape and/or size the medium to stay inside a container of the fluid during and after the dissolution.

Another objective of the present invention is to provide a retainer and enclose the medium with the retainer during the dissolution. Therefore, a related objective of this invention is to provide such a retainer capable of retaining such a medium during the dissolution while containing undesirable debris or particles therein. Another related objective of this invention is to provide the retainer also capable of retaining undissolved fillers therein during and after such dissolution. Another related objective of this invention is to provide the retainer shaped and sized to stay inside a container of the fluid along with the medium therein during and after the dissolution.

Another objective of the present invention is to provide a medium which includes the agent and is capable visualizing an extent of such dissolution. Therefore, a related objective of this invention is to provide the agent defining a color different from that of the fluid and then to visualize the extent of dissolution by a change in color of the fluid as the dissolution progresses. Another related objective of this invention is to provide the filler defining a color different from that of the fluid and to visualize the extent of dissolution by a change in color of the filler dissolved into or suspended in the fluid as the dissolution progresses. Another related objective of this invention is to provide the medium with the filler capable of generating gas when mixed with the fluid and to visualize the extent of dissolution by the amount of gas produced by the filler.

Another objective of the present invention is to provide a medium which includes the agent and forms various particles when dissolved into the fluid. Therefore, a related objective of this invention is to provide the medium which forms such particles floating in the fluid once dissolved therein. Another related objective of this invention is to provide the medium which forms such particles sinking into the fluid when dissolved therein.

Another objective of the present invention is to provide a medium including multiple agents and dissolving such agents in various modes. Therefore, a related objective of this invention is to provide the medium with such agents disposed in radial or concentric arrangements which then dissolve into the fluid sequentially due to their dispositions. Another related objective of this invention is to provide the medium including such agents segregated into different regions in such an arrangement that such agents may dissolve into the fluid simultaneously or sequentially.

Another objective of the present invention is to provide a medium which includes the agent and which defines a structure for facilitating the dissolution of the agent into the fluid. Therefore, a related objective of this invention is to provide the medium from granulated agent and optional filler. Another related objective of this invention is to provide the medium with the macropores and/or micropores for disposing the agent along the pores, thereby facilitating the dissolution of the agent. Another related objective of this invention is to provide the medium with the agent as well as at least one filler capable of facilitating the dissolution of the agent in the fluid by forming the pores, by forming the path for the fluid as the filler dissolves in the fluid, and the like.

It is appreciated in all of such objectives that various media are designed to be dissolved in the fluid contained in bottles of various shapes and sizes. Therefore, such media are preferably shaped and sized to be inserted into or disposed in such bottles. It is also appreciated in the above objectives that each medium includes therein at least one antioxidant and at least one optional filler. Accordingly, the antioxidant is to meet all of the foregoing objectives when the medium does not include the filler or, in the alternative, either or both of the antioxidant and filler are to meet all of the foregoing objectives when the medium includes the antioxidant as well as the filler.

Various media of the present invention may be used to dissolve various agents in the fluid only upon use or consumption, although the primary purpose of such media is to dissolve the antioxidants into various beverages contained in the bottles immediately before use. Therefore, such antioxidants may be dissolved into various bottled waters, bottled beverages, bottled foods, bottled medicine and pharmaceutical substances, bottled nutrients, bottled herbs, and the like, where such bottles waters may include spring water, mineral water, distilled water, flavored water, and carbonated all of which are bottled in various plastic, glass, paper, and/or composite containers, where the bottled beverages may include juice, carbonated beverage, and uncarbonated beverage all of which are bottled in such containers, where the bottled food may include milk, yogurt, and other dairy products all of which are bottled in such containers, and the like.

Various configuration, method, and process aspects of such media and various embodiments thereof are now enumerated. It is to be understood, however, that following configuration, method, and process aspects of the present invention may further be embodied in many other different forms and, accordingly, should not be limited to such aspects and/or their embodiments which are to be set forth herein. Rather, various exemplary aspects and/or their embodiments described hereinafter are provided so that this disclosure is thorough and complete, and fully convey the scope of the present invention to one of ordinary skill in the relevant art.

In one aspect of the present invention, a medium may be provided for protecting its contents from ultraviolet rays.

In one exemplary embodiment of this aspect of the invention, a medium may have at least one antioxidant and at least one filler. The antioxidant tends to be degraded by such rays and dissolves in a fluid, where such an antioxidant is to be referred to as the “first antioxidant” hereinafter. The filler is arranged to be at least substantially opaque to the rays. In addition, the filler is arranged to evenly mix with the antioxidant, whereby a greater portion of the antioxidant may be disposed in an interior of the medium than on an exterior thereof and arranged to be protected from such rays until the medium may be disposed in the fluid.

In another exemplary embodiment of this aspect of the invention, a medium may include at least one first antioxidant and at least one filler which is arranged to dissolve into the fluid and to be at least substantially opaque to the rays, where such a filler is to be referred to as the first filler hereinafter. In addition, the filler is arranged to form at least one coat layer enclosing therein at least a substantial portion of the antioxidant, thereby protecting the antioxidant from such rays until the layer of the filler dissolves in the fluid.

In another exemplary embodiment of this aspect of the invention, a medium may include at least one first antioxidant and at least one first filler. Such an antioxidant and filler are also arranged to be segregated from each other while forming at least one region of the antioxidant as well as at least one region of the filler, where the region of the filler is arranged to enclose at least a substantial portion of the region of the antioxidant therein, thereby protecting the antioxidant region from such rays until the filler region dissolves in the fluid.

In another exemplary embodiment of this aspect of the invention, a medium may include at least one first antioxidant and at least one body. The body is arranged to define multiple layers at least two of which are arranged to include therein at least one of multiple antioxidants, where such at least two of the layers are arranged to include such antioxidants aligned in an order of increasing sensitivity to such rays from an interior of the medium to an exterior thereof, thereby protecting such antioxidants based on their sensitivities to the rays as each layer of the antioxidant is sequentially mixed with the fluid.

In another exemplary embodiment of this aspect of the invention, a medium may include at least one first antioxidant and at least one first filler, where the antioxidant and filler are arranged to define multiple microcapsules in each of which the antioxidant is arranged to be enclosed inside the filler and where the antioxidant is arranged to be protected from the rays until the filler of the capsules may be dissolved in the fluid.

In another aspect of the present invention, a medium may be provided for maintaining a preset position in a fluid when immersed therein.

In one exemplary embodiment of this aspect of the invention, a medium may have at least one first antioxidant and at least one filler. The filler is arranged to have a density greater than that of the fluid and to be mixed with the antioxidant in an amount for rendering the medium have a density which is greater than that of the fluid, thereby rendering the medium sink in the fluid when immersed therein.

In another exemplary embodiment of this aspect of the invention, a medium may include at least one first antioxidant and at least one filler. The filler is arranged to define a density which is less than that of the fluid and to be mixed with the antioxidant in an amount capable of rendering such a medium have a density less than that of the fluid, thereby rendering the medium float on the fluid as immersed thereinto.

In another exemplary embodiment of this aspect of the invention, a medium may include at least one first antioxidant and at least one filler. The filler is arranged to enclose at least one void therein, to have an apparent density which is less than that of the fluid and to be mixed with the antioxidant in an amount capable of rendering the medium have an apparent density less than that of the fluid, thereby rendering the medium float on the fluid when immersed thereinto.

In another exemplary embodiment of this aspect of the invention, a medium may include at least one first antioxidant and at least one retainer which is arranged to be provided as an article separate from the medium, to enclose the medium therein, and then to define multiple openings for allowing the antioxidant and fluid to move thereacross, where this retainer is to be referred to as the “first retainer” hereinafter. The retainer is also arranged to have a weight capable of sinking with the medium in the fluid when immersed thereinto.

In another exemplary embodiment of this aspect of the invention, a medium may include at least one first antioxidant and at least one first retainer which is also arranged to have a weight capable of floating with the medium in the fluid when immersed thereinto.

In another exemplary embodiment of this aspect of the invention, a medium may include at least one first antioxidant and at least one first retainer which is also arranged to define therein at least one void for floating with the medium in the fluid when immersed thereinto.

In another exemplary embodiment of this aspect of the invention, a medium may include at least one first antioxidant and at least one filler. The filler is arranged to be mixed with antioxidant and to be distributed across the medium to form a heavier portion and a lighter portion therein, thereby orienting the lighter portion upward and the heavier portion downward as the medium is immersed into the fluid.

In another exemplary embodiment of this aspect of the invention, a medium may include at least one first antioxidant and at least one first retainer, where the retainer is arranged to define a heavier portion and a lighter portion therein, thereby aligning the lighter portion upward and the heavier portion downward when immersed into the fluid.

In another exemplary embodiment of this aspect of the invention, a medium may include at least one first antioxidant and at least one filler which is arranged to produce gas bubbles when mixed with the fluid, where such a filler is to be referred to as the “first gassifier” hereinafter. The filler is further arranged to be mixed with antioxidant based upon a preset arrangement in the medium and to align the medium in a preset orientation due to the gas bubbles formed according to the arrangement when the medium is immersed into the fluid.

In another aspect of the present invention, a medium may be provided for defining a dimension exceeding a preset threshold value when immersed into a fluid and dissolved therein.

In one exemplary embodiment of this aspect of the invention, a medium may have at least one first antioxidant and at least one filler. Such a filler is arranged to have a structure not dissolving into the fluid, to retain the antioxidant thereover, and to maintain the structure when immersed into the fluid, whereby the medium is arranged to maintain the structure as well during and after dissolution of such an antioxidant in the fluid.

In another exemplary embodiment of this aspect of the invention, a medium may include at least one first antioxidant and at least one filler. The filler is arranged to have a first structure before being immersed into the fluid, to retain the antioxidant thereon, and to swell into a second structure which is bigger than the first structure when immersed in the fluid, whereby the medium is arranged to define a bigger structure during and after dissolution of the antioxidant in the fluid.

In another exemplary embodiment of this aspect of the invention, a medium may include at least one first antioxidant and at least one first retainer. The retainer is arranged to form a structure which defines a preset dimension and does not dissolve into the fluid, whereby such a retainer is arranged to maintain the structure with the dimension during and after dissolution of the antioxidant in the fluid.

In another exemplary embodiment of this aspect of the invention, a medium may include at least one first antioxidant and at least one first retainer. Such a retainer is further arranged to define a first structure before being immersed in the fluid and to swell into a second structure which is bigger than the first structure when immersed in the fluid, whereby the medium is arranged to be enclosed by the retainer with a bigger structure during and after dissolution of the antioxidant in the fluid.

In another aspect of the present invention, a medium may be provided for promoting mixing of at least one of its contents with a fluid.

In one exemplary embodiment of this aspect of the invention, a medium may have at least one first antioxidant and at least one body which includes the antioxidant and also defines a surface area which is arranged to be accessible to the fluid during mixing therewith and to be at least substantially greater than a cross-sectional area of the body, thereby promoting such mixing when the antioxidant mixes with the fluid.

In another exemplary embodiment of this aspect of the invention, a medium may include at least one first antioxidant and at least one body which includes the antioxidant and which is also arranged to define at least one of macropores thereon and micropores therein through each of which such fluid mixes with the antioxidant, thereby promoting the mixing when the antioxidant mixes with the fluid.

In another exemplary embodiment of this aspect of the invention, a medium may include at least one first antioxidant and at least one body containing the antioxidant therein, where the antioxidant is arranged to be segregated in an arrangement that the antioxidant forms a path as being dissolved into the fluid and that the fluid flows into an interior of the medium through the path, thereby promoting the mixing when the antioxidant mixes with the fluid.

In another exemplary embodiment of this aspect of the invention, a medium may include at least one first antioxidant and at least one body which is arranged to include multiple layers concentrically disposed one over the other, where at least two of the layers include each of multiple the antioxidants in an order of increasing solubilities of the antioxidants in the fluid and where the antioxidant defining a less solubility mixes with the fluid earlier than the antioxidant of a greater solubility, thereby promoting such mixing when the antioxidants sequentially mix with the fluid.

In another exemplary embodiment of this aspect of the invention, a medium may include at least one first antioxidant and at least one filler of the first gassifier. The filler is arranged to be mixed with the antioxidant in a preset arrangement and then to generate movement of the medium across the fluid by the gas bubbles due to the arrangement, thereby promoting the mixing when the antioxidant mixes with the fluid.

In another exemplary embodiment of this aspect of the invention, a medium may include at least one first antioxidant and at least one filler of the first gassifier. The filler is arranged to be mixed with the antioxidant in a preset arrangement and to generate movement of such a fluid by the gas bubbles, thereby promoting the mixing when the antioxidant mixes with the fluid.

In another exemplary embodiment of this aspect of the invention, a medium may include at least one first antioxidant and at least one filler of the first gassifier. The filler is arranged to be segregated in such an arrangement that the filler forms a path as being dissolved in the fluid and that the fluid may flow into an interior of the medium through the path, thereby promoting the mixing as the filler is mixed with the fluid.

In another exemplary embodiment of this aspect of the invention, a medium may include at least one first antioxidant and at least one filler of the first gassifier. The filler is arranged to be mixed with the antioxidant and to form at least one of macropores and micropores through each of which the fluid mixes with the antioxidant, thereby promoting the mixing when the filler is mixed with the fluid.

In another exemplary embodiment of this aspect of the invention, a medium may include at least one first antioxidant and at least one first retainer, where the retainer is arranged to form a structure capable of rendering the medium contact with the fluid on all of its sides, thereby promoting the mixing when the medium is immersed in the fluid.

In another exemplary embodiment of this aspect of the invention, a medium may include at least one first antioxidant and at least one filler which is arranged to dissolve into the fluid. The antioxidant and filler are arranged to define multiple microcapsules in each of which the antioxidant is arranged to be enclosed inside the filler, while the antioxidant is arranged to be protected from such rays until the filler of the capsules is dissolved in the fluid.

In another aspect of the present invention, a medium may be provided to visualize dissolution of at least one of its contents in a fluid.

In one exemplary embodiment of this aspect of the invention, a medium may have at least one first antioxidant and at least one first gassifier to visualize an extent of the dissolution by the bubbles.

In another exemplary embodiment of this aspect of the invention, a medium may include at least one first antioxidant and at least one filler which is arranged to be mixed with such an antioxidant in a preset amount and to define a preset density. The medium is arranged to define an apparent density for rendering the medium sink into the fluid before a preset portion of the antioxidant dissolves into the fluid and to define another density for rendering the medium to float on the fluid after the portion of the antioxidant dissolves into the fluid, thereby visualizing the dissolution by position of the medium in the fluid.

In another exemplary embodiment of this aspect of the invention, a medium may also include at least one first antioxidant and at least one filler which is arranged to mix with the antioxidant. Such an antioxidant and filler may be arranged to have multiple microcapsules in each of which the antioxidant is arranged to be enclosed in the filler and to be distinguishable from the fluid, thereby visualizing such dissolution by an amount of the microcapsules which are dispersed in the fluid.

In another exemplary embodiment of this aspect of the invention, a medium may include at least one first antioxidant and at least one filler which is arranged to be mixed with the antioxidant. Such a filler and/or antioxidant may be arranged to define a color which may be distinguishable from the fluid, thereby visualizing the dissolution by the color.

In another exemplary embodiment of this aspect of the invention, a medium may include at least one first antioxidant and at least one filler which may be arranged to define therealong multiple regions with different colors, to support the antioxidant on each of such regions, and to expose such regions with different colors as the antioxidant dissolves in the fluid, thereby visualizing the dissolution by the colors of the filler.

In another aspect of the present invention, a medium may be provided for promoting mixing of at least one of its contents with a fluid by generating gas bubbles by at least another of its contents.

In one exemplary embodiment of this aspect of the invention, a medium may have at least one first antioxidant and at least one first gassifier for promoting mixing of the antioxidant with the fluid.

In another exemplary embodiment of this aspect of the invention, a medium may include at least one first antioxidant and at least one filler of the first gassifier. The filler also defines multiple regions at least two of which are arranged to be distributed in a radial (or concentric) arrangement inside the medium and to sequentially generate the gas bubbles when immersed into the fluid.

In another exemplary embodiment of this aspect of the invention, a medium may include at least one first antioxidant and at least one filler of the first gassifier. The filler is arranged to be distributed in the medium in an uneven arrangement and, accordingly, to generate movement of the medium by the bubbles when immersed into the fluid.

In another exemplary embodiment of this aspect of the invention, a medium may include at least one first antioxidant and at least one filler of the first gassifier. Such a medium is arranged to have an asymmetric shape and the filler is arranged to generate movement of the medium in a preset direction based upon the shape by the bubbles when immersed into the fluid.

In another aspect of the present invention, a medium may be provided to control dissolution of at least one of its contents into a fluid by at least another of its contents.

In one exemplary embodiment of this aspect of the invention, a medium may have at least one first antioxidant and at least one at least filler. The filler is arranged to mix with the antioxidant, to not be dissolved into the fluid, and to maintain its configuration during the dissolution, thereby maintaining mixing between the fluid and antioxidant mixed in the filler during the dissolution.

In another exemplary embodiment of this aspect of the invention, a medium may include at least one first antioxidant and at least one filler. The filler is arranged to retain the antioxidant therein and to be disposed in an arrangement capable of manipulating such fluid to mix with the antioxidant, thereby manipulating a rate of the dissolution as the antioxidant dissolves into the fluid.

In another exemplary embodiment of this aspect of the invention, a medium may include at least one first antioxidant and at least one filler. The filler defines multiple regions at least two of which are arranged to be distributed in a radial (or concentric) arrangement and to retain the antioxidant thereon, thereby manipulating a sequence of the dissolution of the antioxidant in the at least two regions.

In another exemplary embodiment of this aspect of the invention, a medium may include at least one first antioxidant and at least one filler. Such a filler is arranged to be mixed with the antioxidant in such an arrangement that the filler defines a path for the fluid to flow in an interior of such a medium, thereby manipulating a rate of the dissolution as the dissolution progresses.

In another exemplary embodiment of this aspect of the invention, a medium may include at least one first antioxidant and at least one filler. The filler is arranged to have a density greater than that of the fluid and to be mixed with the antioxidant in an amount for rendering the medium to define another density greater than that of the fluid, thereby maintaining the medium to be immersed in the fluid during the dissolution.

In another exemplary embodiment of this aspect of the invention, a medium may include at least one first antioxidant and at least one filler. The filler is arranged to have a density less than that of the fluid and to be mixed with the antioxidant in an amount to render the medium to define another density less than that of the fluid, thereby maintaining the medium to float in the fluid during the dissolution.

In another aspect of the present invention, a medium may be formed for dissolving at least one of its contents with a fluid including:

In one exemplary embodiment of this aspect of the invention, a medium may have at least one first antioxidant and at least one first gassifier. Such openings are arranged to prevent particles of a preset dimension from moving thereacross, thereby containing debris from the medium in the retainer during the dissolving.

In another exemplary embodiment of this aspect of the invention, a medium may include at least one first antioxidant and at least one first retainer. Such a retainer is arranged to prevent the medium from sticking to a container of the fluid, thereby maximizing a surface area available for the dissolving.

In another exemplary embodiment of this aspect of the invention, a medium may include at least one first antioxidant and at least one first retainer which is arranged to have a dimension greater than an outlet of a container of the fluid, thereby containing such a medium inside the container during such dissolving.

In another exemplary embodiment of this aspect of the invention, a medium may include at least one first antioxidant and at least one retainer which is also arranged to have a preset density capable of positioning the medium in a preset position in the fluid when immersed therein.

Embodiments of such apparatus aspects of the present invention may include one or more of the following features, while configurational and/or operational variations and/or modifications of the foregoing media also fall within the scope of the present invention.

Such antioxidants may include the first, second, and/or third antioxidants as described above. The antioxidant may lose its medical potency when exposed to such rays for a preset period of time. The antioxidant may be degraded when dissolved in such fluid for a preset period of time whether or not exposed to the rays. The antioxidant may also form precipitates when dissolved in the fluid for a preset period of time. The antioxidant may not prevent or reduce certain oxidation reactions when exposed to the rays, when dissolved in the fluid for a preset period of time, and/or when precipitated in the fluid.

Such a medium may have thereacross a single antioxidant or multiple antioxidants. The single antioxidant may form an even or uneven distribution in the medium. The single antioxidant may form a symmetric or asymmetric distribution in the medium, may form multiple segregated regions therein, and the like. The segregated regions may be disposed radially (or concentrically), axially, and/or angularly. Such multiple antioxidants may be mixed with each other and distributed thereacross, may form even or uneven distributions in the medium, may form symmetric or asymmetric distributions in the medium, and the like Each of such multiple antioxidants may form different segregated regions in the medium, where the segregated regions of at least one of such multiple antioxidants may be disposed radially (or concentrically), axially, and/or angularly. The antioxidant may be arranged in a distribution to form the macropores and/or micropores before being immersed into the fluid, in another distribution to form the path through the medium as the antioxidant and/or region thereof may dissolve into the fluid, and the like.

The coat layer may enclose an entire (or a preset) portion of an exterior of the medium. Such a coat layer may completely dissolve into the fluid or, alternatively, only a portion of the coat layer may dissolve therein. Such a medium may include multiple coat layers disposed in a radial (or concentric), axial, and/or angular arrangement, while the coat layers may dissolve into the fluid simultaneously or sequentially. The medium may include therein a single filler or multiple fillers. Such a filler may be an insoluble support for retaining the antioxidant thereon, a soluble support for retaining the antioxidant thereon, an insoluble coat for covering the antioxidant, a soluble coat for covering the antioxidant, a gassifier for generating gas, and the like. The single filler may have an even or uneven distribution in the medium, may evenly or unevenly mix with the antioxidant, may define a symmetric or asymmetric distribution in the medium, and the like. The single filler may define multiple segregated regions in the medium. The single filler may be mixed with the antioxidant in none of the regions, at least one of the regions or all of the regions. Such segregated regions may be disposed radially (or concentrically), axially, and/or angularly. Multiple fillers may mix with each other and distributed across the medium. None of, at least one of or all of the multiple fillers may be mixed with the antioxidant. Multiple fillers may have even or uneven distributions in the medium, may have symmetric or asymmetric distributions in the medium, and the like. At least two of multiple fillers may form different segregated regions in the medium. At least one of the regions may include therein a mixture of the antioxidant and at least one of the multiple fillers. Such segregated regions of at least one of the multiple fillers may be disposed radially (or concentrically), axially, and/or angularly. The filler may define a density different from the antioxidant and may be disposed in a preset portion of the medium, thereby defining the top as well as bottom of the medium during the dissolution. Multiple fillers may define different densities and may be preferentially disposed in preset portions of the medium, thereby defining the top and bottom of such a medium during the dissolution. Such a filler may maintain its dimension when immersed into the fluid or may instead swell when immersed thereinto. The filler may be arranged in a distribution to form such macropores and/or micropores before being immersed in such a fluid, in a distribution to form the path through the medium when the filler and/or region thereof dissolve into the fluid, and the like. The filler may also be arranged in a distribution to expose different regions of the medium to the fluid when the antioxidant and/or filler may dissolve in the fluid, thereby mixing the antioxidant in the different regions sequentially with the fluid. The filler may be arranged in a distribution to expose different regions of the medium through different areas as the antioxidant and/or filler may dissolve into the fluid, thereby allowing the fluid to enter the regions in different rates and/or amounts. The medium may include the void in its preset portion, thereby defining the top and bottom thereof during the dissolution.

Both the antioxidant and filler may be formed in solid states. One of the antioxidant and/or filler may be formed in a liquid state and enclosed by the other of the antioxidant and filler which may then be formed in a solid state. The antioxidant and/or filler may define at least one void therein capable of decreasing the apparent density of the medium. The medium may include the antioxidant and/or filler in such a distribution and/or amount that the medium may sink into the fluid when immersed into the fluid, and then may float in the fluid as the preset portion of the antioxidant and/or filler may dissolve into the fluid. Such regions of the filler may be defined radially (or concentrically) so that the regions with the different colors may be exposed sequentially as the antioxidant and/or filler may dissolve into the fluid during the dissolution. The antioxidant and/or filler may define the color different from that of the fluid.

Such a retainer may be made of and/or include plastics, metals, woods, ceramics, composites thereof, and the like. The retainer may have a shape of a mesh including a screen, a net, and the like. The shape of the mesh may define openings having uniform or non-uniform sizes through which the antioxidant and fluid may flow. The retainer may releasably or fixedly retain the medium therein. The medium may be fixed to a preset portion of the retainer during the dissolution or releasably retained in the retainer and move freely therein during the dissolution. The retainer may include at least one void to reduce the apparent density of the medium. Such a retainer may define a heavy portion and a light portion thereof, thereby defining a top and a bottom during the dissolution. The retainer may maintain its dimension when immersed into the fluid or may instead swell when immersed thereinto.

The gassifier may produce CO₂, and/or N₂, whereas such a gassifier may not produce CO, O₂, NOₓ, SOₓ, and the like. The medium may include therein a single gassifier or multiple gassifiers. Such a single gassifier may define an even or uneven distribution in the medium, may define a symmetric or asymmetric distribution in the medium, may form multiple segregated regions in the medium, and so on. The segregated regions may further be disposed radially (or concentrically), axially, and/or angularly. Such multiple gassifiers may be mixed with each other and distributed thereacross, may be evenly or unevenly distributed in the medium, may be symmetrically or asymmetrically distributed in the medium, and the like. Each of multiple gassifiers may form different segregated regions in the medium. Such segregated regions of at least one of multiple gassifiers may be disposed radially (or concentrically), axially, and/or angularly. The distribution of the gassifier in the medium may determine a direction of the movement of the medium by producing the gas bubbles in another direction which is opposite to the direction. The movement of the medium may further be determined by the shape of the medium. The dissolution may be an endothermic reaction and, therefore, cool the fluid thereby. Alternatively, the dissolution may be an exothermic reaction and, thus, heat the fluid thereby. The gassification may be an endothermic reaction and, accordingly, cool the fluid thereby or, in the alternative, may instead be an exothermic reaction and, accordingly, heat the fluid thereby.

In another aspect of the present invention, a method may be provided for protecting at least one content of a medium from ultraviolet rays before dissolving the content into a fluid.

In one exemplary embodiment of this aspect of the invention, a method may have the steps of: providing at least one antioxidant degraded by such rays when exposing thereto (to be referred to as the “first providing” hereinafter); providing at least one filler at least partially opaque to such rays and also soluble in the fluid (to be referred to as the “second providing” hereinafter); making a mixture of the antioxidant and filler (to be referred to as the “first making” hereinafter); and forming the medium of the mixture (to be referred to as the “first forming” hereinafter), thereby distributing a greater portion of the antioxidant in an interior of such a medium than on an exterior thereof, thereby protecting such a greater portion of the antioxidant from the rays before the dissolving.

In another exemplary embodiment of this aspect of the invention, a method may have the steps of: the first providing; the second providing; and then coating at least a portion of the antioxidant with the filler, thereby protecting the antioxidant from the rays before the dissolving.

In another exemplary embodiment of this aspect of the invention, a method may have the steps of: the first providing; the second providing; segregating the antioxidant in at least one region; making a mixture of the filler and the segregated region of the antioxidant; and the above first forming while disposing the segregated region in an interior of the medium, thereby protecting the antioxidant in the region from the rays before the dissolving.

In another exemplary embodiment of this aspect of the invention, a method may have the steps of: the first providing; the second providing; segregating the antioxidant into multiple regions; making a mixture of the filler and the segregated regions of the antioxidant; and the first forming while disposing at least two of the segregated regions in a radial (or concentric) arrangement, thereby protecting the antioxidant segregated in the regions from the rays before the dissolving.

In another exemplary embodiment of this aspect of the invention, a method may have the steps of: the first providing; the second providing; and thereafter microencapsulating the antioxidant by the filler, thereby protecting the antioxidant from the rays before the dissolving.

In another aspect of the present invention, a method may be provided for protecting at least one content of a medium from ultraviolet rays before dissolving the content in a fluid while positioning the medium in a preset position in the fluid during the dissolving.

In one exemplary embodiment of this aspect of the invention, a method may have the steps of: [pa1] the first providing; providing at least one filler which is at least partially opaque to the rays (to be referred to as the “third providing” hereinafter) where the filler is heavier than such a fluid; the first making by including the filler in an amount ensuring such a mixture to be heavier than the fluid; and the first forming, thereby protecting the antioxidant from the rays before such dissolving and then sinking the medium into the fluid during the dissolving.

In another exemplary embodiment of this aspect of the invention, a method may have the steps of: the first providing; the third providing where the filler is lighter than the fluid; the first making by also including the filler in an amount to ensure such a mixture to be lighter than the fluid; and the above first forming, thereby protecting the antioxidant from the rays before the dissolving and floating the medium in the fluid during the dissolving.

In another exemplary embodiment of this aspect of the invention, a method may have the steps of: the first providing; the third providing; the first making; and the first forming while defining at least one void therein, thereby protecting the antioxidant from the rays before the dissolving and floating the medium in the fluid during the dissolving due to the void.

In another exemplary embodiment of this aspect of the invention, a method may have the steps of: the first providing; the third providing; the first making; and then enclosing the medium with a heavy retainer while ensuring transfer of the antioxidant and/or fluid thereacross, thereby protecting such an antioxidant from the rays before the dissolving and sinking the retainer along with the medium in the fluid during the dissolving.

In another exemplary embodiment of this aspect of the invention, a method may have the steps of: the first providing; the third providing; the first making; and enclosing the medium by a light retainer while ensuring transfer of the antioxidant and fluid therethrough, thus protecting the antioxidant from the rays before the dissolving as well as floating the retainer along with the medium in the fluid during the dissolving.

In another exemplary embodiment of this aspect of the invention, a method may have the steps of: the first providing; the third providing; the first making; forming a retainer defining at least one void therein; and enclosing the medium by the light retainer while insuring transfer of the antioxidant and fluid therethrough, thereby protecting the antioxidant from the rays before the dissolving and floating the medium in the fluid during the dissolving due to the void.

In another exemplary embodiment of this aspect of the invention, a method may have the steps of: the first providing; the third providing; the first making; and the first forming while distributing such a filler to form a top and a bottom of the medium, thereby protecting the antioxidant from the rays while ensuring the medium to orient in a direction from the top to the bottom during the dissolving.

In another exemplary embodiment of this aspect of the invention, a method may have the steps of: the first providing; the third providing; the first making; forming a retainer defining a lighter top and a heavier bottom; and enclosing the medium by the retainer, thereby protecting the antioxidant from the rays and ensuring the retainer and the medium to orient in a direction from the top to the bottom during the dissolving.

In another exemplary embodiment of this aspect of the invention, a method may have the steps of: the first providing; providing at least one filler at least partially opaque to the rays and also capable of generating gas when mixed with the fluid (to be referred to as the “fourth providing” hereinafter); the first making; and then the first forming, thereby protecting the antioxidant from the rays before the dissolving and moving the medium in the fluid by the gas during the dissolving.

In another aspect of the present invention, a method may be provided for protecting at least one content of a medium from ultraviolet rays before dissolving the content into a fluid while ensuring the medium to stay inside a container of the fluid.

In one exemplary embodiment of this aspect of the invention, a method may have the steps of: the first providing; the third providing where the filler is not soluble in the fluid; the first making; and the above first forming while forming at least one axis of the medium with the filler, thereby protecting the antioxidant from the rays before the dissolving and also ensuring the medium to define the axis during the dissolving.

In another exemplary embodiment of this aspect of the invention, a method may have the steps of: the first providing; the third providing where the filler swells in the fluid; the first making; and then the first forming while forming at least one axis of the medium with such a filler, thereby protecting the antioxidant from the rays before the dissolving and also ensuring the medium to expand the axis due to the swelling during the dissolving.

In another exemplary embodiment of this aspect of the invention, a method may have the steps of: the first providing; the third providing; the first making; forming a retainer not soluble in the fluid; and then enclosing the medium by the retainer, thereby protecting the antioxidant from the rays before the dissolving and ensuring the retainer to maintain its dimension during the dissolving.

In another exemplary embodiment of this aspect of the invention, a method may have the steps of: the first providing; the third providing where the filler swells in the fluid; the first making; forming a retainer not soluble in the fluid but swelling in the fluid; and then enclosing the medium by the retainer, thereby protecting the antioxidant from the rays before the dissolving and also ensuring the retainer to expand due to the swelling during the dissolving.

In another aspect of the present invention, a method may be provided for protecting at least one content of a medium from ultraviolet rays before dissolving the content into a fluid while promoting mixing between the content and fluid during the dissolving.

In one exemplary embodiment of this aspect of the invention, a method may have the steps of: the first providing; the third providing; the first making; and the first forming while exposing a maximum amount of the antioxidant, thereby protecting the antioxidant from the rays before the dissolving while promoting the mixing due to the exposing during the dissolving.

In another exemplary embodiment of this aspect of the invention, a method may have the steps of: the first providing; the third providing; the first making while providing therein micropores; and then the first forming while providing therein macropores, thereby protecting the antioxidant from such rays before the dissolving and promoting the mixing through at least one of the pores during the dissolving.

In another exemplary embodiment of this aspect of the invention, a method may have the steps of: the first providing; the third providing; the first making; and the first forming while distributing such an antioxidant to form a path for the fluid after the dissolving, thereby protecting the antioxidant from the rays before the dissolving and promoting the mixing through the path during the dissolving.

In another exemplary embodiment of this aspect of the invention, a method may have the steps of: the first providing; the third providing; the first making; and the first forming while distributing such antioxidants in each of multiple concentric regions according to solubilities thereof in the fluid, thereby protecting the antioxidant from the rays before the dissolving and promoting the mixing by first mixing the antioxidant with a lower solubility with the fluid first during the dissolving.

In another exemplary embodiment of this aspect of the invention, a method may have the steps of: the first providing; the fourth providing; the first making; and the first forming, thereby protecting the antioxidant from such rays before the dissolving and promoting the mixing by moving the medium and/or fluid through the generating during the dissolving.

In another exemplary embodiment of this aspect of the invention, a method may have the steps of: the first providing; the fourth providing; the first making; and the first forming while distributing the filler to form a path for the fluid after the dissolving, thereby protecting the antioxidant from such rays before the dissolving as well as promoting the mixing through the path during the dissolving.

In another exemplary embodiment of this aspect of the invention, a method may have the steps of: the first providing; the third providing where the filler is soluble in the fluid; the first making; and the first forming while distributing the filler to form a path for the fluid after the above dissolving, thereby protecting the antioxidant from the rays before the dissolving as well as promoting the mixing through the path during the dissolving.

In another aspect of the present invention, another method may also be provided for protecting at least one content of a medium from ultraviolet rays before dissolving the content into a fluid while visualizing an extent of the dissolving.

In one exemplary embodiment of this aspect of the invention, a method may have the steps of: the first providing; the fourth providing; the first making; and the first forming, thereby protecting such an antioxidant from the rays before the dissolving while visualizing the extent by such bubbles during the dissolving.

In another exemplary embodiment of this aspect of the invention, a method may have the steps of: the first providing; the third providing where the filler is not soluble into the fluid and has a density different from that of the antioxidant; the first making; and then the first forming, thereby protecting the antioxidant from the rays before the dissolving while rendering the medium decrease its density and visualizing the extent by the medium sinking during an initial phase of the dissolving and floating at a final phase thereof.

In another exemplary embodiment of this aspect of the invention, a method may have the steps of: the first providing; the third providing; the first making; and then microencapsulating the antioxidant by the filler, thereby protecting the antioxidant from the rays before the dissolving while visualizing the extent by microcapsules dispersed in the fluid during the dissolving.

In another exemplary embodiment of this aspect of the invention, a method may have the steps of: the first providing; the third providing; the first making where the antioxidant and/or filler may define a color different from that of the fluid; and the first forming, thereby protecting the antioxidant from the rays before the dissolving while visualizing the extent by the color of the mixture dispersed in the fluid during the dissolving.

In another exemplary embodiment of this aspect of the invention, a method may have the steps of: the first providing; the third providing where the filler is not soluble into the fluid and forms multiple regions with different colors; the first making while retaining the antioxidant over each of the regions of the filler; and the first forming, thereby protecting the antioxidant from the rays before the dissolving while visualizing the extent by exposing each of the colors during the dissolving.

In another aspect of the present invention, a method may be provided for protecting at least one content of a medium from ultraviolet rays before dissolving the content into a fluid while promoting mixing of the content with the fluid by generating gas during the dissolving.

In one exemplary embodiment of this aspect of the invention, a method may have the steps of: the first providing; the fourth providing; the first making while uniformly mixing the antioxidant with the filler; and the first forming, thereby protecting the antioxidant from such rays before the dissolving and promoting the mixing by moving the medium and/or fluid by the gas during the dissolving.

In another exemplary embodiment of this aspect of the invention, a method may have the steps of: the first providing; the fourth providing; the first making; and the first forming while forming multiple concentric regions including the filler therein, thereby protecting the antioxidant from such rays before the dissolving while also promoting the mixing sequentially generating the gas in the regions during the dissolving.

In another exemplary embodiment of this aspect of the invention, a method may have the steps of: the first providing; the fourth providing; the first making; and then the first forming while unevenly distributing such a filler inside the medium, thereby protecting the antioxidant from the rays before the dissolving and promoting the mixing by moving the medium in the fluid during the dissolving.

In another exemplary embodiment of this aspect of the invention, a method may have the steps of: the first providing; the fourth providing; the first making; and then the first forming in an asymmetric shape, thus protecting the antioxidant from the rays before the dissolving while promoting the mixing by moving the medium in a preset orientation the fluid during the dissolving.

In another aspect of the present invention, a method may be provided for protecting at least one content of a medium from ultraviolet rays before dissolving the content in a fluid while controlling mixing between the content and fluid.

In one exemplary embodiment of this aspect of the invention, a method may have the steps of: the first providing; the third providing where the filler is not soluble in the fluid; the first making; and the first forming while defining at least one axis with the filler, thereby protecting the antioxidant from the rays before the dissolving while maintaining the axis and a dimension thereof during the dissolving.

In another exemplary embodiment of this aspect of the invention, a method may have the steps of: the first providing; the third providing where the filler is soluble in the fluid; the first making; and the first forming while disposing the antioxidant and/or filler in a preset arrangement, thereby protecting the antioxidant from the rays before the dissolving and manipulating a rate of the dissolving based on the arrangement during the dissolving.

In another exemplary embodiment of this aspect of the invention, a method may have the steps of: the first providing; the third providing; the first making; and the first forming while disposing the filler and/or antioxidant in a concentric (or radial) arrangement, thereby protecting the antioxidant from such rays before the dissolving and manipulating a sequence of the dissolving based upon the arrangement during the dissolving.

In another exemplary embodiment of this aspect of the invention, a method may have the steps of: the first providing; the third providing; the first making; and the first forming while disposing the filler and/or antioxidant in a preset arrangement, thereby protecting the antioxidant from the rays before the dissolving and providing a path for the fluid through an interior of the medium during the dissolving.

In another exemplary embodiment of this aspect of the invention, a method may have the steps of: the first providing; the third providing; the first making where the filler defines an apparent density greater than that of the fluid; and the above first forming, thereby protecting the antioxidant from such rays before the dissolving while maintaining the medium immersed in the fluid during the dissolving.

In another exemplary embodiment of this aspect of the invention, a method may have the steps of: the first providing; the third providing; the first making where the filler defines an apparent density less than that of the fluid; and the first forming, thereby protecting the antioxidant from the rays before the dissolving while maintaining the medium floating in the fluid during the dissolving.

Embodiments of such method aspects of the present invention may include one or more of the following features, and configurational and/or operational variations and/or modifications of the above methods also fall within the scope of the present invention.

The exposing may include one of the steps of: irradiating the rays to the antioxidant before the dissolving; irradiating the rays to the antioxidant after the dissolving, and the like. The dissolving may include at least one of the steps of: forming anions and/or cations of the antioxidant; forming hydrated substances thereof; forming suspension and/or emulsion thereof; dispersing particles thereof in such a fluid, and the like. The dissolving may include one of the steps of: dissolving an entire portion of the antioxidant; dissolving only a portion of the antioxidant, and the like.

The providing such an antioxidant may include one of the steps of: providing the antioxidant in a concentration present in its natural state; concentrating the antioxidant, and the like. The providing the antioxidant may include at least one of the steps of: preferentially disposing the antioxidant in the interior of the medium; and uniformly distributing the antioxidant throughout the medium. The providing the antioxidant may be replaced by at least one of such steps of: providing the antioxidant degraded over a period of the dissolving in the fluid; providing the antioxidant degraded by forming a precipitate, and the like. The providing the antioxidant and/or filler may further include at least one of the steps of: providing the antioxidant and/or filler in the solid state; providing the antioxidant and/or filler in the liquid state; and the like. The above providing the filler may include at least one of the steps of: manipulating a transmittivity of the rays through the filler; and manipulating a thickness of the filler. Such providing the filler may include the step of: providing multiple fillers at least one of which is opaque to the rays.

The making the mixture may include one of the steps of: evenly mixing the antioxidant in such a filler; unevenly mixing the antioxidant with the filler; and forming segregated regions of the filler and/or antioxidant. The making such a mixture may include at least one of the steps of: mixing the antioxidant and filler defining the same size or different sizes; mixing the antioxidant and filler defining the same or different shapes; and mixing the antioxidant and filler in the same or different states. Such making the mixture may include at least one of such steps of: including the filler to improve binding therebetween; including the filler to define the micropores therealong; including the filler as a surfactant for the fluid, and the like. The making the mixture may include at least one of the steps of: mixing the antioxidant with the filler as they are; adding at least one solvent for the making; applying heat during the making; and the like.

Such forming the medium may include at least one of the steps of: shaping such a medium into a symmetric (or asymmetric) article; shaping the medium as a solid article without defining therein any void; providing at least one void in (or through) the medium, and the like. The forming the medium may include at least one of the steps of: shaping the mixture inside a mold; heating the mixture; dehydrating the mixture, and the like. The forming the medium may include one of the steps of: evenly distributing the mixture in the medium; disposing the mixture on another filler not soluble in the fluid; disposing the mixture on another filler soluble in the fluid, and the like. The coating may include at least one of the steps of: covering an entire (or only a) portion of the antioxidant; forming a single layer of the coating; forming multiple layers of the coating; forming the layer of the coating extending into the interior of the medium, and the like. The segregating may have one of the steps of: forming multiple regions in each of which only one of the filler and antioxidant is included; and forming multiple regions in at least one of which both of the filler and antioxidant are included. The forming the regions may include at least one of the steps of: disposing the regions in an axial arrangement; disposing the regions in an angular arrangement; disposing the regions in a radial and/or concentric arrangement; disposing the regions symmetrically relative to a center and/or an edge of the medium; disposing the regions asymmetrically; disposing at least one of the regions in another of the regions, and the like.

Such sinking the medium may include one of the steps of: maintaining the density greater than that of the fluid throughout the dissolving; maintaining the greater density only in the initial phase of the dissolving; and changing the density during the course of the dissolving. The floating the medium may have one of the steps of: maintaining the density less than that of the fluid throughout the dissolving; maintaining the less density only during the final phase of the dissolving; changing the density during the course of the dissolving, and the like.

The forming the retainer may include at least one of the steps of: fabricating the retainer of at least one substance not soluble in the fluid; sizing the retainer to be greater than a dimension of an outlet of a container for the fluid, and the like. The enclosing the medium may include at least one of the steps of: releasably disposing the medium inside the retainer; and fixedly attaching the medium to the retainer. Such enclosing the medium may include one of the steps of: including a single medium inside the retainer; and disposing multiple media inside the retainer. The ensuring such transfer may include the step of: arranging the openings to define diameters greater than a few millimeters, a few hundred microns, and the like. The promoting the mixing may also include at least one of the steps of: destroying a mass transfer boundary layer near the antioxidant and/or filler; forming convective mixing by the movement of the antioxidant and/or filler by the gas, and the like. The promoting the mixing may include at least one of the steps of: manipulating a direction of the movement of the medium by the gas bubbles; manipulating the position of the medium inside the fluid, and the like. The swelling may include at least one of the steps of: expanding the filler and/or retainer by absorbing such a fluid therein; and unfolding folded portions of the filler and/or retainer. The exposing the antioxidant may include at least one of the steps of: preferentially disposing the antioxidant along the macropores and/or micropores; preferentially disposing the antioxidant on the exterior of the medium; disposing the antioxidant with the filler soluble in the fluid, and the like.

In another aspect of the present invention, a medium may be provided for protecting its content from ultraviolet rays.

In one exemplary embodiment of this aspect of the invention, such a medium may be made by a process including the steps of: including at least one antioxidant which tends to be degraded by such rays and dissolves in a fluid in the medium (to be referred to as the “first including” hereinafter); and evenly mixing with the antioxidant at least one filler which is arranged to be at least partially opaque to the rays, whereby disposing a greater portion of the antioxidant in an interior of the medium than on an exterior thereof and protecting the portion of the antioxidant from such rays before the medium is disposed in the fluid.

In another exemplary embodiment of this aspect of the invention, a medium may be made by a process including such steps of: the first including; selecting at least one filler which is arranged to dissolve into the fluid and to be also at least partially opaque to the rays (to be referred to as the “first selecting” hereinafter); and coating the antioxidant by at least one layer of the filler, thereby protecting the antioxidant from the rays before the layer of the filler dissolves in the fluid.

In another exemplary embodiment of this aspect of the invention, a medium may be made by a process including the steps of: the first including; selecting at least one filler which is arranged to be at least partially opaque to such rays (to be referred to as the “second selecting” hereinafter); and segregating the antioxidant and filler from each other while defining at least one region of the filler and at least one region of the antioxidant and enclosing the region of the antioxidant with the region of the filler, thereby protecting the antioxidant region from the rays before the region of the filler dissolves in the fluid.

In another exemplary embodiment of this aspect of the invention, a medium may be made by a process including such steps of: the first including; forming multiple layers at least two of which are arranged to include therein at least one of multiple the antioxidants; and including in such at least two of the layers the antioxidants aligned in an order of increasing sensitivity to the rays from an interior of the medium to an exterior thereof, thereby protecting the antioxidants based on their sensitivities to the rays as each layer of the antioxidant is sequentially mixed with the fluid.

In another exemplary embodiment of this aspect of the invention, such a medium may be made by a process including such steps of: the first including; the first selecting; and then defining multiple microcapsules by enclosing the antioxidant in the filler, thereby protecting the antioxidant from such rays before the filler of the capsules is dissolved in the fluid.

In another aspect of the present invention, a medium may be provided for protecting at least one of its contents from ultraviolet rays before dissolving the at least one of the contents into a fluid.

In one exemplary embodiment of this aspect of the invention, such a medium may be made by a process including the steps of: the first including; the second selecting; mixing the antioxidant and filler (to be referred to as the “first mixing” hereinafter); and shaping such a mixture into the medium (to be referred to as the “first shaping” hereinafter), thereby distributing a greater portion of the antioxidant in an interior of the medium than on an exterior thereof and also protecting the greater portion of such an antioxidant from the rays before the dissolving.

In another exemplary embodiment of this aspect of the invention, a medium may be made by a process including the steps of: the first including; the first selecting; and disposing a layer of the filler covering at least a portion of the antioxidant, thereby protecting the antioxidant from the rays before the dissolving.

In another exemplary embodiment of this aspect of the invention, a medium may be made by a process including the steps of: the first including; the second selecting; segregating the antioxidant into at least one region; mixing the filler and segregated region of the antioxidant; and the first shaping while disposing the segregated region in an interior of the medium, thereby protecting the antioxidant in the region from the rays before the dissolving.

In another exemplary embodiment of this aspect of the invention, a medium may be made by a process including the steps of: the first including; the second selecting; segregating the antioxidant into multiple regions; mixing the filler and the segregated regions of the antioxidant; and then the first shaping while disposing at least two of the segregated regions in a radial or concentric arrangement, thereby protecting the antioxidant segregated in the regions from the rays before the dissolving.

In another exemplary embodiment of this aspect of the invention, such a medium may also be made by a process including such steps of: the first including; the first selecting; and forming multiple microcapsules of the antioxidant encapsulated with the filler, thereby protecting the antioxidant from the rays before the dissolving.

In another aspect of the present invention, a medium may be provided for promoting mixing of its content with a fluid.

In one exemplary embodiment of this aspect of the invention, such a medium may be made by a process including the steps of: the first including; and forming such a medium by the antioxidant while maximizing its surface area, thereby promoting the mixing when the antioxidant mixes with the fluid.

In another exemplary embodiment of this aspect of the invention, a medium may be made by a process including the steps of: the first including; and forming such a medium by the antioxidant while providing therein macropores and/or micropores in each of which the fluid flows during such mixing, thereby promoting the mixing as the antioxidant mixes with the fluid.

In another exemplary embodiment of this aspect of the invention, a medium may be made by a process including the steps of: the first including; and forming the medium by the antioxidant in such an arrangement that the antioxidant forms a path as being dissolved in the fluid and that the fluid flows into an interior of the medium through such a path, thereby promoting the mixing when the antioxidant mixes with the fluid.

In another exemplary embodiment of this aspect of the invention, a medium may be made by a process including the steps of: the first including; forming the medium in multiple layers concentrically disposed one over another; and including in at least two of the layers each of multiple antioxidants in an order of increasing solubilities of the antioxidants in the fluid from an exterior of the medium to an interior thereof, thereby promoting the mixing when the antioxidants sequentially mix with the fluid.

In another exemplary embodiment of this aspect of the invention, such a medium may be made by a process including the steps of: the first including; selecting at least one filler which is arranged to produce gas when mixed with the fluid (to be referred to as the “third selecting” hereinafter); the first mixing; and the first shaping in a preset arrangement for generating movement of the medium across the fluid by the gas due to the arrangement, thereby promoting the mixing when the antioxidant mixes with the fluid.

In another exemplary embodiment of this aspect of the invention, a medium may be made by a process including the steps of: the first including; the third selecting; and then the first mixing, thereby generating movement of the fluid with the gas and promoting the mixing as the antioxidant mixes with the fluid.

In another exemplary embodiment of this aspect of the invention, a medium may be made by a process including the steps of: the first including; the third selecting; the first mixing; and then the first shaping in such an arrangement that the filler forms a path as being dissolved in the fluid and that the fluid flows into an interior of the medium through the path, thereby promoting the mixing when the filler is mixed with the fluid.

In another exemplary embodiment of this aspect of the invention, a medium may be made by a process including the steps of: the first including; the second selecting; the first mixing; and the first shaping while forming macropores and/or micropores through each of which the fluid mixes with the antioxidant, thereby protecting the antioxidant from the rays before the mixing and then promoting the mixing when the filler is mixed with the fluid.

In another aspect of the present invention, a medium may be provided for protecting its content from ultraviolet rays before dissolving the content in a fluid and promoting mixing between the content and the fluid during the dissolving.

In one exemplary embodiment of this aspect of the invention, such a medium may be made by a process including such steps of: the first including; the second selecting; the first mixing; and the first shaping while exposing a maximum amount of the antioxidant, thereby protecting the antioxidant from the rays before the dissolving while promoting the mixing due to the exposing during the dissolving.

In another exemplary embodiment of this aspect of the invention, a medium may be made by a process including the steps of: the first including; the second selecting; the first mixing while providing therein micropores; and the first shaping while providing therein macropores, thereby protecting the antioxidant from the rays before the dissolving while promoting the mixing through at least one of the pores during the dissolving.

In another exemplary embodiment of this aspect of the invention, a medium may be made by a process including the steps of: the first including; the second selecting; the first mixing; and the first shaping while distributing such an antioxidant to form a path for the fluid after the dissolving, thereby protecting the antioxidant from the rays until the dissolving and promoting the mixing through the path during the dissolving.

In another exemplary embodiment of this aspect of the invention, a medium may be made by a process including the steps of: the first including; the second selecting; the first mixing; and the first shaping while distributing the antioxidant in each of multiple concentric regions based upon solubilities thereof in the fluid, thereby protecting the antioxidant from the rays before the dissolving as well as promoting the mixing by first mixing the antioxidant with a lower solubility with the fluid first during the dissolving.

In another exemplary embodiment of this aspect of the invention, a medium may be made by a process including the steps of: the first including; the third selecting where the filler is at least partially opaque to the rays; the first mixing; and the first shaping, thereby protecting the antioxidant from the rays before such dissolving and promoting the mixing by moving at least one of the medium and fluid through the generating during the dissolving.

In another exemplary embodiment of this aspect of the invention, a medium may be made by a process including the steps of: the first including; the third selecting where the filler is at least partially opaque to the rays; the first mixing; and the first shaping, while distributing the filler to form a path for the fluid after the dissolving, thereby protecting the antioxidant from the rays before the dissolving as well as promoting the mixing through the path during the dissolving.

In another exemplary embodiment of this aspect of the invention, a medium may be made by a process including the steps of: the first including; the first selecting; the first mixing; and then the first shaping while distributing the filler to form a path for the fluid after the dissolving, thereby protecting the antioxidant from the rays before the dissolving as well as promoting the mixing through the path during the dissolving.

In another aspect of the present invention, a medium may be provided to visualize dissolution of at least one of its contents in a fluid.

In one exemplary embodiment of this aspect of the invention, such a medium may be made by a process including the steps of: the first including; and the third selecting, thereby visualizing an extent of the dissolution by the bubbles.

In another exemplary embodiment of this aspect of the invention, a medium may be made by a process including the steps of: the above first including; selecting at least one filler which is arranged to define a preset density; mixing the antioxidant and filler in such amounts that the mediums sink in the fluid during an initial phase of the dissolution and then that the medium floats on the fluid during a final phase of the dissolution, thereby visualizing the dissolution by position of the medium in the fluid.

In another exemplary embodiment of this aspect of the invention, a medium may be made by a process including the steps of: the first including; and imparting the antioxidant with a color different from that of the fluid, thereby visualizing the dissolution by the color of the antioxidant.

In another exemplary embodiment of this aspect of the invention, a medium may be made by a process including the steps of: the first including; and selecting at least one filler soluble in the fluid and defining a color different from that of the fluid, thereby visualizing the dissolution by the color of the filler during the dissolution.

In another exemplary embodiment of this aspect of the invention, a medium may be made by a process including the steps of: the first including; selecting at least one filler which defines therealong multiple regions having different colors; and supporting the antioxidant on each of the regions, thereby visualizing the dissolution by the colors of the filler as the antioxidant dissolves into the fluid during the dissolution.

More product-by-process claims may be constructed by modifying the foregoing preambles of the apparatus (or system) claims and/or method claims and by appending thereto such bodies of the apparatus (or system) claims and/or method claims. In addition, such process claims may include one or more of such features of the apparatus (or system) claims and/or method claims of this invention.

As used herein, the term “antioxidants” refers to various natural and/or synthetic substances which are capable of preventing certain oxidation reactions or at least reducing rates of the oxidation reactions. Typical examples of natural “antioxidants” are various tocopherols including α-, β-, γ-, and δ-tocopherols, nordihydroguaretic acid (or NDGA), sesamol, and gossypol, whereas typical examples of synthetic “antioxidants” are butylated hydroxy-anisole (or BHA), butylated hydroxy-toluene (or BHT), propyl gallate (or PG), and tertiary butyl hydroquinone (or TBHQ). These “antioxidants” are believed to prevent or reduce the oxidation reactions caused by various reactive oxygen species such hydrogen peroxide (H₂O₂), superoxide anion (O₂⁻), various free radicals including hydroxyl radical (OH⁻), and the like. Various metal chelators also behave as such “antioxidants,” where examples of such chelators are phosphoric acid, citric acid, ascorbic acid (or vitamin C), ethylene diamine tetra acetate (or EDTA). All of the “antioxidants” disclosed in this paragraph will be referred to as the “antioxidants” of the first type throughout this disclosure.

In addition to the foregoing substances, many more “antioxidants” are known in various fields of food, medicine, and pharmaceutical industries, where the “antioxidants” may be classified as food additive “antioxidants” or nutritional “antioxidants” and where the latter may further be classified as vitamins, vitamin cofactors and minerals, hormones, carotenoid terpenoids, non-carotenoid terpenoids, flavonoid polyphenolics, phenolic acids and esters, other organic “antioxidants,” and so on. The food additive “antioxidants” may include, but not be limited to, ascorbic acid (or vitamin C), tocopherol and tocopherol-derived compounds, BHA, BHT, EDTA, citric acid, acetic acid, pectin, rosemarinic acid, and the like. Such vitamin “antioxidants” may include, but not be limited to, vitamin A (or retinol), vitamin C (or ascorbic acid), and vitamin E including tocotrienol, tocopherol, and the like. The vitamin cofactors “antioxidants” and mineral “antioxidants” may include, but not be limited to, coenzyme Q10 (or CoQ10), selenium, zinc, manganese (particularly in its 2⁺ valence state and as a part of an enzyme, superoxide dismutase or SOD), and so on. The hormone such as melatonin may also operate as the “antioxidant.” The carotenoid terpenoids “antioxidants” may include, but not limited to, lycopene, lutein, α-carotene, β-carotene, zeaxanthin, astaranthin, and canthaxantin. The non-carotenoid terpenoids “antioxidants” may include, but not be limited to, eugenol, saponin, limonoid, and the like. The flavonoid polyphenolics “antioxidants” (or biofalvonoids) are a subset of polyphenyl “antioxidants” and may include falvonoids, flavones, flavanones, falvan-3-ols, isoflavone phytoestrogenes, and anthocyanins. Such flavonoids may also include, but not be limited to, resveratrol, pterostilbene, kaempferol, myricetin, isorhamnetin, proanthocyanidins or condensed tannins, and the like. The flavones may include, but not be limited to, quercetin, rutin, luteolin, apigenin, tangeritin, and so on. The flavanones may include, but not be limited to, hesperetin, naringenin, and eriodictyol. Such falvan-3-ols or anthocyanidins may include, but not be limited to, catechin, gallocatechin, opicatechin and its gallate forms, epigallocatechin and its gallate forms, theaflavin and its gallate forms, and thearubigin. Isoflavone phytoestrogens may include, but not be limited to, genistein, daidzein, glycitein, and the like. The anthocyanins may include, but not be limited to, delphinidin, malvidin, pelargonidin, peonidin, petunidin, and the like. The phenolic acids and esters “antioxidants” are a subset of polyphenol “antioxidants” and may include, but not be limited to, ellagic acid, gallic acid, salicylic acid, rosemarinic acid, cinnamic acid including its derivatives such as ferulic acid, chlorogenic acid, chicolic acid, gallotannin, and ellagitannin. Other organic “antioxidants” may also include, but not be limited to, citric acid, lignan, antinutrients such as oxalic acid and phytic acid, bilirubin, uric acid, R-α-lipoic acid, silymarin, N-acetylcysteine, and the like. Other “antioxidants” may further include α-tocopherol, α-tocoquinone, indole, sulforaphane, glucosinate, and the like. All of these “antioxidants” described in this paragraph will be referred to as the “antioxidants” of the second type throughout this disclosure.

As used herein, the term “antioxidants” may collectively refer to various foods which include any of the “antioxidants” described in the previous paragraph. Accordingly, such “antioxidants” may include, but not be limited to, (undutched) cocoa powder, (dark) chocolate, white tea, green rooibes, green tea, oolong tea, black tea, blueberry, blackberry, raspberry, cranberry, crowberry, kiwi, cherry, plum, grape, pomegranite, papaya, orange, grapefruit, other citrus fruits, cruciferous vegetable such as broccoli, Brussels sprout, cabbage, and kale, artichoke, asparagus, avocado, bean, spinach, red pepper, carrot, (Russet) potato, tomato, olive, various nuts such as walnut, pecan, hazelnut, and the like. Similarly, the term “antioxidants” may collectively refer to various herbs and spices which may also include any of the “antioxidants” disclosed in the preceding paragraph, where examples of such herbs and spices may further include, but not be limited to, allspice, cinnamon, cloves, ginger, lemon balm, oregano, peppermint, rosemary, sage, thyme, and the like. All of these foods, herbs, fruits, and the like, will be referred to as the “antioxidants” of the third type throughout this disclosure. It is to be understood, therefore, that the terms “antioxidant” and “antioxidants” collectively refer to those of the first, second, and third types, unless otherwise specified.

As used herein, a term “agent” collectively refers to the above antioxidants which have been described in the preceding three paragraphs. Such an “agent” also refers to other vitamins, minerals, nutrients, herbs, medicinal substances, pharmaceutical substances, and/or homeopathic substances which fall into one or more of following three types. First, the “agents of the first type” refer to those which tend to lose their potency and/or activity and/or which tend to degrade by ultraviolet rays (to be abbreviated as the “UV rays” hereinafter). In contrary, the “agents of the second type” refer to those which tend to lose their potency or activity and/or which tend to degrade when they are dissolved in a fluid beyond a preset period of time. In addition, the “agents of the third type” refer to those which tend to form precipitations and/or aggregates by the UV rays and/or when dissolved in a fluid beyond such a period of time. It is to be understood, however, that the terms “agent” and “agents” collectively refer to those of the first, second, and third types, unless otherwise specified.

A “bottle” refers to any rigid or elastic container which may contain therein a preset amount of fluid which may by definition include suspension, emulsion, slurry, a mixture of liquid and solid, and the like. The “bottle” may be made of and/or include various polymers or plastics, glasses, metals, papers, ceramics, papers, composite materials thereof, and the like. Such “bottles” refer not only to portable “bottles” but also to stationary “bottles,” where the portable “bottles” are generally smaller and contain less fluid than the stationary “bottles.” In addition, such “bottles” refer not only to disposable “bottle” but also to other “bottles” which may be used repeatedly.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A to 1C are schematic perspective views of exemplary media before (left panels) and after being dissolved (right panels) in a fluid according to the present invention;

FIGS. 2A to 2J are schematic perspective views of exemplary media with various shapes and sizes according to the present invention;

FIGS. 3A to 3J are partially cutaway schematic views of exemplary media including therein one or multiple agents according to the present invention;

FIGS. 4A to 4O are partially cutaway schematic views of exemplary media having therein one or more fillers and defining spherical shapes according to the present invention; and

FIGS. 4P to 4T are partially cutaway schematic views of exemplary media having therein one or more fillers and defining cylindrical shapes according to the present invention.

### DETAILED DESCRIPTION OF THE PREFERRED EMBODIMENTS

The present invention generally relates to various media for protecting antioxidants contained therein from degradation before use. More particularly, the present invention relates to media which are to be dissolved in a fluid before use and to protect antioxidants contained therein from ultraviolet rays (to be referred to as the “UV rays” hereinafter) and/or from degradation caused by a prolonged period of dissolution in the fluid. To this end, such media are provided with various fillers capable of being mixed with the antioxidants and protecting the antioxidants from the UV rays before mixing with the fluid, capable of isolating such antioxidants from the fluid, and the like. The present invention also relates to various media capable of promoting dissolution of the antioxidants into the fluid when such media are immersed into the fluid. More particularly, the antioxidant and/or a mixture thereof with one or more fillers may form suitable structures promoting dissolution of the antioxidant into the fluid, may form pores therein for promoting flow of the fluid into various portions of the media, and the like. The present invention also relates to various media containing the fillers capable of generating gas when mixed with the fluid so that the gas bubbles move the media in the fluid and that the fluid adjacent to such media is mixed the antioxidant, thereby promoting mixing between the antioxidant and fluid.

The present invention relates to various methods of protecting the antioxidants contained in the media from the UV rays and prolonged period of dissolution into the fluid. To these ends, the present invention relates to various methods of disposing the antioxidant in the media in suitable arrangements, various methods of forming the media capable of isolating or segregating the antioxidant from the fluid before use, various methods of forming the media while providing paths of the fluid to the antioxidants which is disposed in the media, and the like. The present invention also relates to various methods of promoting mixing between the fluid and antioxidants and/or fillers and, therefore, dissolution thereof in the fluid. More particularly, the present invention relates to various methods of providing such media with various pores along which the antioxidant is distributed and in which the fluid flows in, various methods of forming the path for the fluid while the antioxidant or filler dissolves into the fluid, various methods of promoting such mixing by generating gas and moving the medium and/or fluid therearound, various methods of maintaining positions of the media in the fluid during the dissolution, and the like.

The present invention also relates to various processes for providing various media protecting the antioxidants contained therein from the UV rays and prolonged period of dissolution into the fluid. More particularly, the present invention relates to various processes for providing various media with structures for isolating the antioxidant from such UV rays, various processes for forming pores inside the media and segregating the antioxidant therealong, various processes for disposing the antioxidant and/or filler in and on the media, and the like. The present invention also relates to various processes for providing the media capable of promoting the mixing and dissolution of the antioxidant into the fluid. More particularly, the present invention relates to various processes for providing the media capable of forming the path for the fluid to flow into an interior of the media, capable of maintaining its position in the fluid during such dissolution, capable of alleviating resistances to molecular and/or convective mass transfer by generating movement of such media and/or fluid, capable of visualizing an extent of the dissolution by various means, and the like.

Various aspects and embodiments of various media, methods, and processes of the present invention will now be described more particularly with reference to the accompanying drawings and text, where these aspects and/or embodiments thereof only represent different forms. Such media, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various members, units, elements, and parts of various media of the present invention are not typically drawn to scales and/or proportions for ease of illustration. It is also to be understood that such members, units, elements, and/or parts of various media of this invention designated by the same numerals typically represent the same, similar, and/or functionally equivalent members, units, elements, and/or parts thereof, respectively.

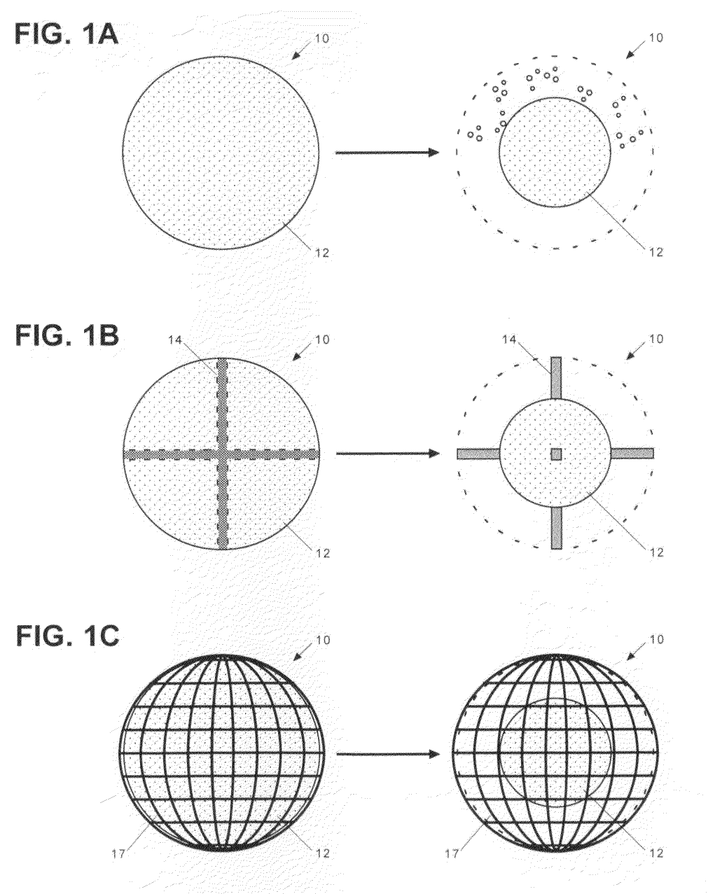

In one aspect of the present invention, a medium may be arranged to dissolve into a fluid while decreasing its size in proportion with an extent of dissolution of an antioxidant and/or an optional filler into the fluid. FIG. 1A shows a schematic perspective view of an exemplary spherical medium before (a left panel) and after being dissolved (a right panel) in a fluid according to the present invention. An exemplary medium 10 is formed as a sphere and includes at least one agent 12 or, more specifically, at least one antioxidant 12 (see the left panel). The medium 10 also includes at least one filler capable of producing gas such as, e.g., CO₂, when mixed with the fluid, where such a filler will be referred to as a “gassing agent” or a “gassifier” hereinafter. It is appreciated in this embodiment that such a filler and antioxidant are distributed uniformly across the medium 10. Accordingly, as the filler reacts with the fluid and generates the gas (denoted by small circles in the figure), the antioxidant 12 exposed to the fluid also dissolves in the fluid. Accordingly, the medium 10 decreases its size in proportion with the extent of dissolution (see the right panel). It is appreciated in this aspect of the invention that both of the antioxidant 12 and filler are soluble in the fluid and that the medium 10 mixes with the fluid along a moving boundary which gradually moves inwardly and toward a center of the medium 10. Because the antioxidant and filler are uniformly distributed thereacross, the medium 10 also decreases its size uniformly in all directions while maintaining a similar but smaller spherical shape.

In another aspect of the invention, a medium may be arranged to maintain its dimension along at least one axis thereof while the antioxidant contained therein dissolves in a fluid. FIG. 1B describes a schematic perspective view of another exemplary spherical medium including a soluble antioxidant and an insoluble filler before (a left panel) and after being dissolved (a right panel) in a fluid according to the present invention. An exemplary medium 10 is also formed as a sphere and similarly includes at least one soluble agent or antioxidant 12 and at least one insoluble filler 14. More particularly, the filler 14 extends from one end to an opposing end along its diameter, where this embodiment describes the filler 14 which extends in all three directions and is shaped as an assembly of three rods each having a length of a diameter of the medium 10 and coupled to each other at right angles. The antioxidant 12 is disposed over or on the filler 14 or, in other words, the filler 14 receives and retains the antioxidant 12 thereon while defining the spherical surface of the medium 10. As described in the left panel, the antioxidant 12 is filled up to bury opposing ends of the filler 14 thereunder. As the agent or antioxidant 12 dissolves in the fluid, a boundary between the antioxidant 12 and fluid recedes toward a center of the medium 10, while the insoluble filler 14 maintains its shape and size. Accordingly and as depicted in the right panel, the filler 14 gradually exposes three pairs of its opposing ends through the receding antioxidant 12 while maintaining an original dimension of the medium 10. Other configurational and/or operational characteristics of the medium of FIG. 1B are similar or identical to those of the medium of FIG. 1A.

In another aspect of the invention, a medium may be arranged to include a retainer which may enclose an exterior of the medium for various purposes. FIG. 1C is a schematic perspective view of an exemplary medium with a retainer before (a left panel) and after being dissolved (a right panel) in a fluid according to the present invention. An exemplary medium 10 is shaped as a sphere, includes an agent or antioxidant 12 and optional filler, and is otherwise similar to those of FIGS. 1A and 1B. Such a medium 10 also includes in a retainer 17 which is shaped as an annular sphere defining an interior in which the medium 10 is disposed. The retainer 17 forms a mesh or screen defining multiple openings such that the antioxidant 12, filler, and fluid may move thereacross, where shapes and/or sizes of the openings may vary. This retainer 17 may be incorporated for various purposes. In one example, the retainer 17 is used to contain undesirable debris or particles formed during dissolution therein and to prevent such debris or particles from seeping into the fluid. Thus, an user may drink the fluid without including such debris and particles when the medium 10 is to be dissolved into the fluid contained in a bottle. In another example, the retainer 17 is made of an insoluble substance and maintains its shape and size during and after the dissolution such that the medium 10 maintains its shape and size during and after the dissolution as well. Accordingly, such a medium 10 may not escape through an outlet of the bottle as the medium 10 is to be dissolved in the fluid contained in the bottle. As will be described in detail below, such a retainer 17 may be made of and/or include a substance which may swell when mixed with the fluid. Thereby, the user may easily insert the retainer 17 into the bottle while ensuring such a medium 10 to remain inside the bottle during and after such dissolution. Further configurational and/or operational characteristics of the medium of FIG. 1C may be similar or identical to those of such media of FIGS. 1A and 1B.

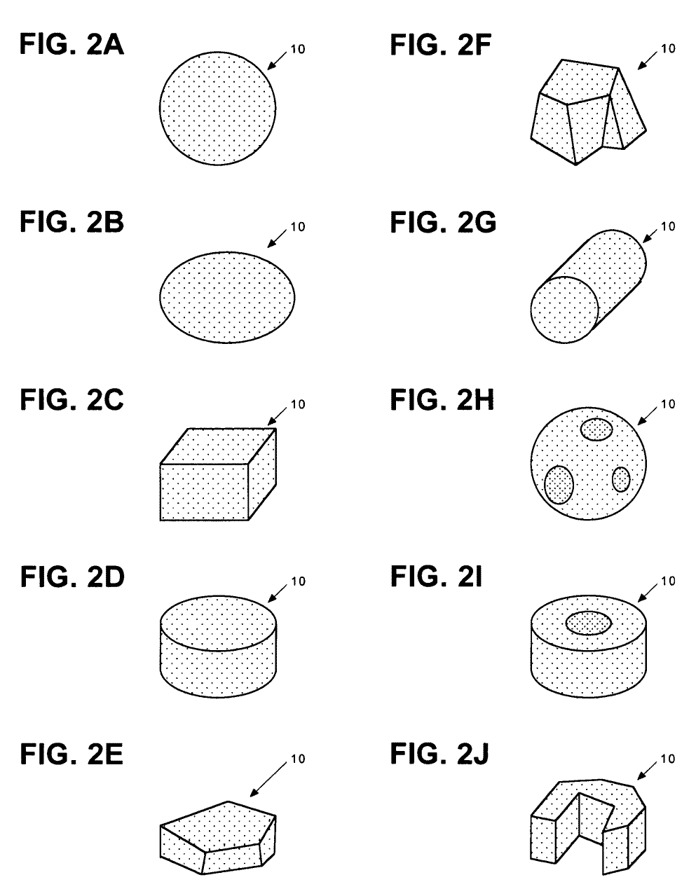

In another aspect of the present invention, a medium may be fabricated in various shapes and sizes as long as such a medium may include a preset amount of an agent or antioxidant as well as a preset amount of one or more optional fillers, as long as such a medium may be inserted into a bottle defining an opening of a preset shape and size, as long as such a medium may facilitate dissolution of the agent or antioxidant and/or fillers, and the like. FIGS. 2A to 2J are schematic perspective views of exemplary media with various shapes and sizes according to the present invention. It is appreciated in each figure that the medium may include therein only one agent (or antioxidant), multiple agents (or antioxidants) without any fillers, one or more agents (or antioxidants) with one or more fillers, and the like. In addition and although not included in the figures, such media may also include various retainers enclosing therein the media.

In one exemplary embodiment of this aspect of the invention and as described in FIGS. 2A and 2B, a medium 10 may be shaped as a sphere (FIG. 2A) or as an oblong spheroid (FIG. 2B), into which an agent (or antioxidant) and/or filler may be incorporated in various arrangements. An exact size of each of the media 10 may depend upon various design factors such as, e.g., a desired amount of the agent (or antioxidant) to be included in each medium 10, a number of media 10 to be disposed in each bottle of a fluid in which the media 10 are to be dissolved, an amount of the filler to be mixed with the agent (or antioxidant) in each medium 10, and the like.

In another exemplary embodiment of this aspect of the invention and as described in FIGS. 2C to 2F, a medium 10 may be shaped as a curvilinear three-dimensional object which forms an arbitrary cross-sectional shape in each direction along the x-, y-, and z-axes. For example, a medium 10 may be shaped as a cube (FIG. 2C), as a cylindrical pellet (FIG. 2D), as another pellet defining pentagonal top and bottom (FIG. 2E), and as yet another pellet defining different geometrical shapes in its top and bottom (FIG. 2F). An exact size of each of such media 10 may also be determined by various factors described in the previous paragraph.

In another exemplary embodiment of this aspect of the invention and as described in FIG. 2G, a medium 10 may be shaped as a rod defining various cross-sections, where the embodiment of such a figure defines a cylindrical rod. A diameter and/or a height of the medium 10 may also be determined by various factors described above.

In another exemplary embodiment of this aspect of the invention and as described in FIGS. 2H to 2J, a medium 10 may be shaped to define one or more gaps or macropores therein or thereacross, where such gaps or macropores are intended to serve as paths for a fluid during the dissolution and, therefore, to facilitate the dissolution. For example, a spherical medium 10 of FIG. 2H defines multiple gaps or macropores which may extend into preset depths thereinto and which may interconnect each other. In another example of FIG. 2I, a medium 10 of a cylindrical pellet of FIG. 2D defines a center gap or macropore extending an entire height of the medium 10. In another example of FIG. 2J, a medium 10 of FIG. 2E forms in one corner thereof an indentation which serves as a gap or macropore into which the fluid may access and mix with the agent (or antioxidant) and/or filler.

It is appreciated in FIGS. 2A to 2J that the medium 10 may be fabricated in other shapes and/or sizes as long as such a medium 10 may contain desired amounts of the agent (or antioxidant) and/or fillers therein and as long as such shapes may allow desirable mixing between the fluid and the agent (or antioxidant) and/or filler. It is also appreciated in such figures that the medium 10 may define any number of such gaps and/or macropores as far as the medium 10 may contain the desired amounts of the agent (or antioxidant) and/or fillers therein and as long as such shapes may allow desirable mixing between the fluid and the agent (or antioxidant) and/or filler. It is again iterated that the main function of various media 10 is to be dissolved into the fluid when mixed therewith and that such media 10 may not necessarily have to maintain their mechanical integrity during the dissolution. Therefore, as far as the media 10 may only have to maintain their shapes and/or sizes during handling and disposition into the bottle, but such media 10 may break into pieces or may crumble upon being mixed with the fluid.

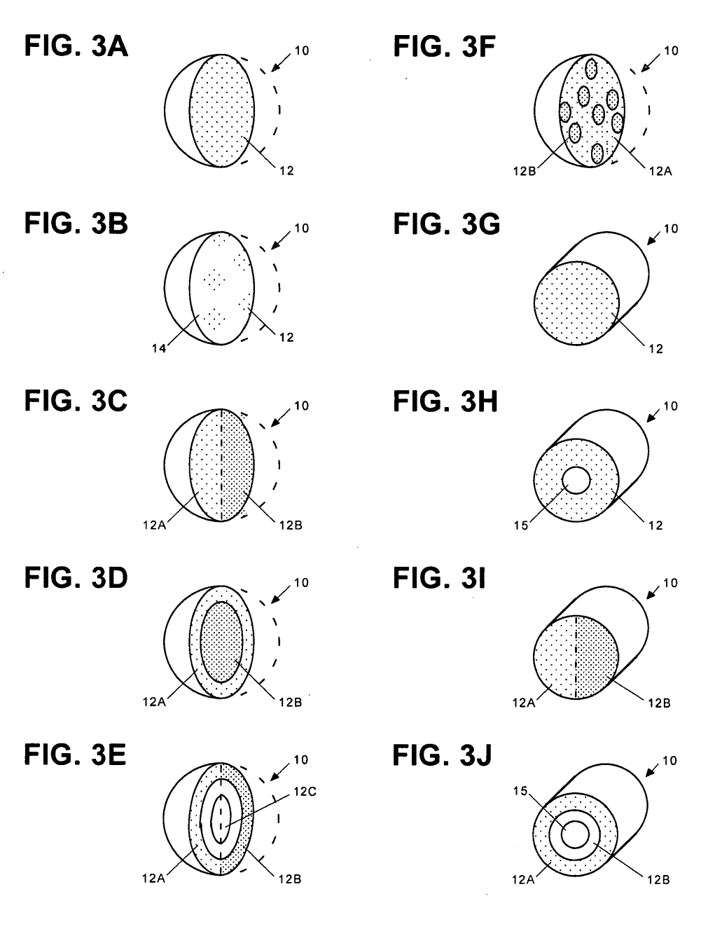

In another aspect of the present invention, such a medium may include two or more agents (or antioxidants) in various arrangements as long as such a medium may include a preset amount of each agent or antioxidant as well as a preset amount of one or more optional fillers, as long as the medium may define a shape and/or size capable of being inserted into a bottle defining an opening of a preset shape and size, as long as such a medium may facilitate dissolution of the agent or antioxidant and/or fillers, and the like. FIGS. 3A to 3J are partially cutaway schematic views of exemplary media which include one or multiple agents (or antioxidants) according to the present invention. It is appreciated in each figure that the medium may define any shapes and/or sizes as long as such a medium meets the above requirements, that the medium may include one or more fillers, and so on. For example, various media of FIGS. 3A to 3F are chosen as the spherical or ellipsoidal media of FIGS. 2A and 2B, whereas those media of FIGS. 3G to 3J are selected as the cylindrical pellets of FIG. 2G, although various media of FIGS. 3A to 3J may define any other shapes and sizes as disclosed in this description and may also define one or more gaps or macropores therein or therealong. In addition, such media of FIGS. 3A to 3G may also include various retainers enclosing therein the medium.

In one exemplary embodiment of this aspect of the invention and as represented in FIG. 3A, a medium 10 includes a single agent (or antioxidant) 12 distributed uniformly thereacross. A size of this medium 10 may be decided by the same factors described in the above paragraphs. It is appreciated that the medium 10 of this embodiment consists of the single agent (or antioxidant) 12 and that such a medium 10 is expected to decrease its size in proportion with an extent of dissolution of the agent (or antioxidant) 12 into the fluid. Other configurational and/or operational characteristics of the medium of FIG. 3A are similar or identical to those of the media of FIGS. 1A to 1C and FIGS. 2A to 2J.

In another exemplary embodiment of this aspect of the invention and as described in FIG. 3B, a medium 10 consists of one or more agents (or antioxidants) 12 and one or more fillers 14, where the agents (or antioxidants) 12 may be mixed with the fillers 14 in an even or uneven arrangement. In the embodiment of the figure, the medium 10 forms a matrix in which the fillers 14 form a matrix, while the agents (or antioxidants) 12 are preferentially distributed in each of multiple segregated regions which are distributed evenly across the medium 10. Other configurational and/or operational characteristics of the medium of FIG. 3B are similar or identical to those of the media of FIGS. 1A to 1C, FIGS. 2A to 2J, and FIG. 3A.

In another exemplary embodiment of this aspect of the invention and as described in FIGS. 3C to 3F, each medium 10 defines multiple regions each of which includes a single agent (or antioxidant) 12 and an optional filler. In one example of FIG. 3C, such a medium 10 defines a pair of hemispheres which preferentially include only one of the agents (or antioxidants) 12A, 12B. In another example of FIG. 3D, a medium 10 includes an inner spherical region and an outer annular region which is shaped and/or sized to enclose the inner region 12B therein. Similar to that of FIG. 3C, each region includes only one of the agents (or antioxidants) 12A, 12B. In another example of FIG. 3E, such a medium 10 includes multiple layers which are disposed one over the other in a concentric or radial arrangement. More particularly, an outer layer defines a pair of identical regions each including different agents (or antioxidants) 12A, 12B therein, a middle layer forms another pair of identical regions each including different agents (or antioxidants) 12A, 12B therein in a zigzag pattern, and also an inner layer forming another pair of identical regions each including therein different agents 12A, 12B (or antioxidants) in the zigzag pattern. In another example of FIG. 3F, such a medium 10 includes a matrix including only one of the agents (or antioxidants) 12A and multiple segregated regions each including another of the agents 12A, 12B therein. Further configurational and operational characteristics of the media of FIGS. 3C to 3F may be similar or identical to those of the media of FIGS. 1A to 1C, FIGS. 2A to 2J, and FIGS. 3A and 3B.

In another exemplary embodiment of this aspect of the invention and as described in FIG. 3G, a cylindrical medium 10 includes a single agent (or antioxidant) 12 distributed uniformly thereacross. A size of this medium 10 may be decided by the same factors described in the above paragraphs. It is appreciated that the medium 10 of this embodiment consists of the single agent (or antioxidant) 12 and that the medium 10 is expected to decrease its size in both of axial and radial directions in proportion with an extent of dissolution of the agent (or antioxidant) 12 into the fluid. Other configurational and/or operational characteristics of the medium of FIG. 3G may be similar or identical to those of the media of FIGS. 1A to 1C, FIGS. 2A to 2J, and FIGS. 3A to 3F.

In another exemplary embodiment of this aspect of the invention and as described in FIGS. 3H to 3J, each medium 10 defines multiple regions each of which includes a single agent (or antioxidant) 12 and an optional filler, where such regions may be formed with respect to a longitudinal axis of the cylindrical medium 10. In one example of FIG. 3H, such a medium 10 forms an annular cylinder which defines an inner void 15 along its axis and includes one or more agents (or antioxidants) 12 which are distributed in an even or uneven distribution axially and/or radially. In another example of FIG. 3I, such a medium 10 includes a pair of identical half-cylinders which include different agents (or antioxidants) 12A, 12B therein. In another example of FIG. 3J, another medium 10 includes a pair of regions which are disposed radially or concentrically with respect to each other and which include different agents (or antioxidants) 12A, 12B therein. Other configurational and operational characteristics of the media of FIGS. 3H to 3J are similar or identical to those of such media of FIGS. 1A to 1C, FIGS. 2A to 2J, and FIGS. 3A to 3G.

It is appreciated in FIGS. 3A through 3J that various regions of the media 10 may be formed to define identical or different shapes and/or sizes, that such regions may be disposed in a symmetric or asymmetric arrangement, and the like. Each of such regions may also include therein different agents (or antioxidants) 12 with or without any fillers, each of the regions may include at least one common agent (or antioxidant) 12 while also incorporating at least one different agent (or antioxidant) 12, each of such regions may include therein at least one different filler, and the like.

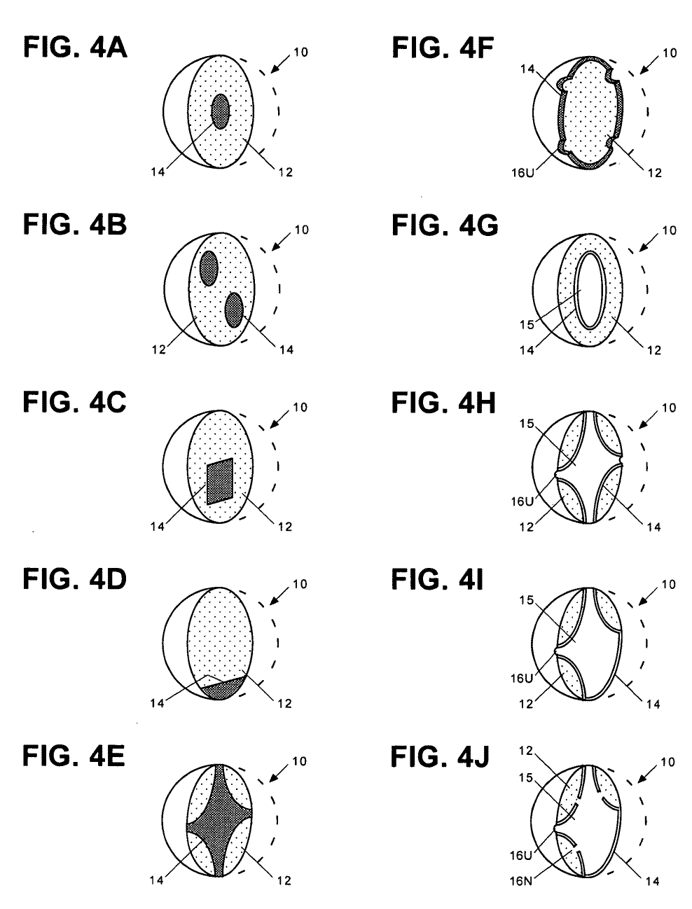

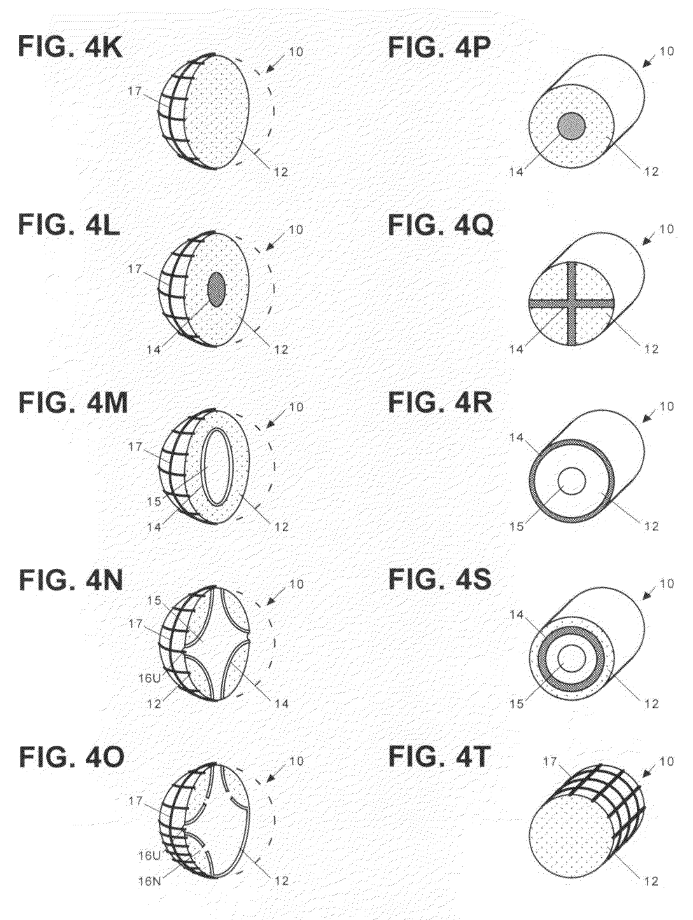

In another aspect of the present invention, such a medium may include one or multiple agents (or antioxidants) and one or more fillers in various arrangements as long as the medium may include a preset amount of each agent or antioxidant and a preset amount of each filler, as long as the medium may define a shape and/or size capable of being inserted into a bottle defining an opening of a preset shape and size, as long as such a medium may facilitate dissolution of the agent or antioxidant and/or fillers, and the like. FIGS. 4A to 4O are partially cutaway schematic views of exemplary media having therein one or more agents (or antioxidants) and fillers and defining spherical shapes according to the present invention. It is appreciated in each figure that the medium may have any shapes and/or sizes as long as such a medium meets the above requirements. For example, various media of FIGS. 4A to 4O are chosen as the spherical or ellipsoidal media of FIGS. 2A and 2B, whereas those media of FIGS. 4P to 4T are selected as the cylindrical pellets of FIG. 2G, although various media of FIGS. 4A through 4T may define any other shapes and sizes as disclosed in this description and may also define one or more gaps and/or macropores therein or therealong. It is also appreciated that various fillers of such media of FIGS. 4A to 4T may be arranged to be soluble to the fluid, to be only partially soluble to such a fluid or to be insoluble thereto. In addition, the media of FIGS. 4A through 4T may also include various retainers capable of enclosing therein entire (or only) portions of the media therein.

In one exemplary embodiment of this aspect of the invention and as described in FIGS. 4A to 4D, each medium forms a matrix (or a major region) and one or multiple segregated regions, where the matrix includes therein one or more agents (or antioxidants) and optional fillers, while the segregated regions preferentially include therein one or more fillers. In one example of FIG. 4A, a medium 10 has a spherical or ellipsoidal shape of FIG. 2A or 2B and forms a center spherical region with at least one filler 14 and an annular spherical region enclosing therein the center region 14 and including therein at least one agent (or antioxidant) 12. Therefore, such a medium 10 decreases its size as the agent (or antioxidant) 12 contained in the outer region dissolves into a fluid, where a further change in its size depends on a solubility of the filler 14 which is disposed in such an inner region. In another example of FIG. 4B, a medium 10 is generally similar to that of FIG. 4A, except that such a medium 10 includes two or more segregated regions of the same or different fillers 14. Such regions 14 may be formed in a symmetric or asymmetric arrangement with respect to a center of the medium 10 or other landmarks thereof. In another example of FIG. 4C, a medium 10 is also similar to that of FIG. 4A, except that the medium 10 includes a segregated region of the filler 14 which does not have a circular cross-section and that such a region 14 may be disposed in an off-center position inside the medium 10. In another example of FIG. 4D, a medium 10 is similar to that of FIG. 4A, except that a single segregated region of the filler 14 is disposed close to or to define a surface of the medium 10. Other configurational and/or operational characteristics of the media of FIGS. 4A to 4D are similar or identical to those of the media of FIGS. 1A to 1C, FIGS. 2A to 2J, and FIGS. 3A to 3J.

In another exemplary embodiment of this aspect of the invention and as described in FIGS. 4E and 4F, each medium similarly forms a matrix and one or multiple segregated regions, where the matrix includes therein one or more agents (or antioxidants) and optional fillers, while the segregated regions preferentially include therein one or more fillers and defines at least a portion of an exterior of such a medium not only before and but also during and/or after dissolution of the agent or antioxidant into the fluid. In one example of FIG. 4E, such a medium 10 defines another spherical or ellipsoidal shape and includes a segregated region of one or more fillers 14 which occupies a center of the medium 10 and extends onto various portions of an exterior of the medium 10. The matrix of the agent (or antioxidant) 12 is then formed by depositing or coating the agent (or antioxidant) 12 on and over the filler 14 until the agent (or antioxidant) 12 forms an exterior of the medium 10 while burying the segregated region of the filler 14 thereunder. Depending upon a solubility thereof, the segregated region of the filler 14 may maintain its shape and size or may dissolve into the fluid at the same rate as, at a faster rate than or at a slower rate than the agent (or antioxidant) 12. In another example of FIG. 4F, a medium defines another spherical or ellipsoidal shape but includes a segregated region of one or more fillers 14 on its exterior. That is, such a segregated region 14 forms an exterior of the medium 10, while including the agent (or antioxidant) 12 therein. The segregated region also defines one or multiple outer openings 16U for allowing the fluid to seep into an interior of the medium 10 and for allowing the dissolved agent (or antioxidant) 12 to move out to the exterior thereof. Similar to that of FIG. 4E, the segregated region may be insoluble to the fluid or may dissolve at a slower rate than the agent (or antioxidant) 12. Other configurational and operational characteristics of the media of FIGS. 4E and 4F are similar or identical to those of the media of FIGS. 1A to 1C, FIGS. 2A to 2J, FIGS. 3A to 3J, and FIGS. 4A to 4D.

In another exemplary embodiment of this aspect of the invention and as described in FIGS. 4G to 4J, each medium includes one or more agents (or antioxidants) and one or more fillers, where such a filler forms at least one void inside the medium, while the agent (or antioxidant) is disposed over or on the filler. In one example of FIG. 4G, such a medium 10 includes an annular spherical or ellipsoidal region of a filler 14 which defines a void 15 therein as well as a layer of an agent (or antioxidant) 12 disposed over the filler region 14 at an uniform thickness, whereby the medium 10 also has a shape of a sphere or an ellipsoid. Accordingly, such a medium 10 may define an apparent density less than that of the fluid and may float on the fluid during the dissolution of the agent (or antioxidant) 12 into the fluid. In another example of FIG. 4H, a medium 10 is similar to that of FIG. 4G, except that one or more outer openings 16U are provided on an exterior of the medium 10. Accordingly, the fluid may enter an interior of the medium 10 when the medium 10 is immersed into the fluid. When the filler 14 is insoluble to the fluid, such openings 16U may render the fluid to occupy the inner void 15 of the medium 10 and may sink the medium 10 in the fluid. In addition, the medium 10 may maintain its shape and size during and after the dissolution. In contrary, when the filler 14 is soluble into the fluid, the fluid may dissolve the filler 14 and contact the agent (or antioxidant) 12 in an interior of the medium 10, thereby promoting the dissolution of the agent (or antioxidant) 12 not only from the exterior but also in the interior. When the filler 14 produces the gas when mixed with the fluid, such gas may escape the medium 10 through the openings 16U. Accordingly, the medium 10 may be arranged to move in the fluid in a desired mode by distributing the openings 16U in a proper arrangement on the exterior of the medium 10. In another example of FIG. 4I, a medium is typically similar to that of FIG. 4H, except that the segregated region of the filler 14 is asymmetric and, accordingly, that the void 15 defined thereby is also asymmetric. Thus, such a medium 10 tends to float on the fluid in a preset orientation, e.g., by disposing a portion defining the most void 15 upward and another portion including the most agent (or antioxidant) 12 downward. In another example of FIG. 4J, a medium 10 is similar to that of FIG. 4I but forms multiple inner openings 16N along the segregated region of the filler 14. Accordingly, regardless of a solubility of the filler 14, the fluid may then flow into the interior of the medium through the outer openings 16U and contact the agent (or antioxidant) 12 from inside, thereby facilitating the dissolution of the agent (or antioxidant) 12. Other configurational and/or operational characteristics of the media of FIGS. 4G to 4J may be similar or identical to those of the media of FIGS. 1A to 1C, FIGS. 2A to 2J, FIGS. 3A to 3J, and FIGS. 4A to 4F.

In another exemplary embodiment of this aspect of the invention and as described in FIGS. 4K to 4O, each medium includes one or more agents (or antioxidants) and one or more optional fillers and also includes a retainer capable of enclosing the rest of the medium 10 therein. Therefore, a medium 10 may be similar to any of those of FIGS. 3A to 3E but includes a retainer 17 similar to that of FIG. 1C in an example of FIG. 4K, while a medium 10 is similar to that of FIG. 4A but includes a retainer similar to that of FIG. 4K in the case exemplified in FIG. 4L. In these examples, such retainers 17 may define densities greater than those of the agent (or antioxidant) 12 and/or fluid, thereby facilitating the media 10 to sink into the fluid. In other examples of FIGS. 4M to 4O, media 10 are similar to those of FIGS. 4G, 4H, and 4J, respectively, where each medium 10 is also enclosed by a similar retainer 17. In all these examples, the retainers 17 may be made of and/or include a substance which has a density similar to or less than the fluid so that the media 10 may define apparent densities which may be less than that of the fluid and may, thus, may float in the fluid during and after the dissolution. Other configurational and/or operational characteristics of the media of FIGS. 4K to 4O may be similar or identical to those of the media of FIGS. 1A to 1C, FIGS. 2A to 2J, FIGS. 3A to 3J, and FIGS. 4A to 4J.

In another exemplary embodiment of this aspect of the invention and as described in FIGS. 4P to 4S, each medium forms a cylindrical shape and includes one or more agents (or antioxidants) and one or more optional fillers therein. In one example of FIG. 4P, a medium 10 forms an inner cylindrical segregated region with one or more fillers 14 which is enclosed by an outer annular cylindrical matrix of one or more agents (or antioxidants) 12. Such a segregated region of the filler 14 may be disposed along a longitudinal axis of the medium 10 or may instead be disposed off such an axis or at an angle with respect to the axis. In another example of FIG. 4Q, a medium 10 includes a segregated region of the filler 14 which forms a shape of a cross extended in a longitudinal direction. The medium 10 also includes the agent (or antioxidant) 12 which is disposed on or over the filler region 14 and defines an exterior of the medium 10. In another example of FIG. 4R, a medium 10 is similar to that shown in FIG. 3H, except that a segregated region of the filler 14 encloses the agent (or antioxidant) 12 therein. The filer 14 may be soluble to the fluid so that the agent (or antioxidant) 12 dissolves into the fluid after at least a portion of the filler 14 dissolves and then exposes the agent (or antioxidant) 12 to the fluid. In the alternative, the filler 14 may be insoluble to the fluid so that the agent (or antioxidant) 12 dissolves into the fluid which flows thereinto and mixes therewith through the void 15 formed inside the medium 10. In another example of FIG. 4S, a medium 10 is similar to that of FIG. 3H, except that a segregated region of the filler 14 is provided through a middle of an annular matrix of the agent (or antioxidant) 12, thereby forming an upper annular layer as well as a lower annular layer of the agent (or antioxidant) 12. When made of a substance insoluble to the fluid, the filler 14 physically and functionally divides the agent (or antioxidant) 12 into two regions, each of which may dissolve in different rates or may serve different functions. When made of a soluble substance, however, such a filler 14 may provide a time lag between dissolution of the outer layer of the agent (or antioxidant) 12 and dissolution of the inner layer thereof. Similar to those of FIGS. 4A to 4D, such segregated regions 14 of FIGS. 4P to 4S may be made of and/or include the filler 14 soluble or insoluble to the fluid, may also render the medium 10 heavier or lighter than the fluid, may instead control a weight distribution of the medium 10, and the like. Similar to those of FIGS. 4G to 4J, such segregated regions 14 of FIGS. 4P through 4S may define one or more voids inside the media 10 so as to reduce the apparent densities of the media 10. Further configurational and/or operational characteristics of the media of FIGS. 4P to 4S are similar or identical to those of the media of FIGS. 1A to 1C, FIGS. 2A to 2J, FIGS. 3A to 3J, and FIGS. 4A to 4O.

In another exemplary embodiment of this aspect of the invention and as described in FIG. 4T, a medium forms a cylindrical shape, has one or more agents (or antioxidants) and one or more optional fillers, and further includes a retainer capable of enclosing the rest of the medium 10 therein. Thus, a medium 10 of FIG. 4T is similar to that of FIG. 3G. Other configurational and operational characteristics of the media of FIG. 4T may be similar or identical to those of the media of FIGS. 1A to 1C, FIGS. 2A to 2J, FIGS. 3A to 3J, and FIGS. 4A to 4S.

It is to be understood that various segregated regions of the filler 14 exemplified in FIGS. 4A to 4S and/or similar regions of such agents (or antioxidants) may be incorporated into such media 10 for various purposes. For example, the filler 14 may be selected as a substance which defines a density which is different from that of the agent (or antioxidant) 12, which is different from that of the fluid in which the medium 10 is to be dissolved, and the like. Therefore, an overall or apparent density of the medium 10 may be decided by manipulating the shape and/or size of the segregated region of the filler 14, a number of the segregated regions to be included in the medium 10, and the like, whereby such a medium 10 may be arranged to be heavier or lighter than the fluid so that the medium 10 may sink in or float on the fluid, respectively, during and/or after the dissolution of the agent (or antioxidant) 12 in the fluid. In another example, locations and/or arrangements of the segregated regions may be controlled so that the medium 10 may exhibit an uneven weight distribution while maintaining its apparent density. Such a medium 10 may then orient itself during the dissolution along a preset direction determined by its weight distribution. Therefore, the media 10 of FIGS. 4C and 4D sink in the fluid while orienting the segregated regions 14 downward when the filler 14 may be heavier than the agent (or antioxidant) 12 and/or fluid or, alternatively, float in the fluid while orienting the segregated regions upward when the filler 14 is lighter than the agent 14 and/or fluid. The segregated regions of the filler 14 may instead be employed to maintain a dimension of the medium 10 during and after the dissolution. For example, the segregated region may be arranged to extend from one end to another end of the medium 10 or, in the alternative, from one interior position to another interior and/or exterior position thereof. In general, the segregated region is made of and/or include the substance insoluble to the fluid, similar to that shown in FIG. 1B.

Configurational and/or operational variations and/or modifications of the above embodiments of the exemplary media, various regions or layers thereof, various agents (or antioxidants) and/or fillers, and various retainers described in FIGS. 1A to 4T also fall within the scope of this invention.

As described above, various media of the present invention may include any of the foregoing first, second, and third antioxidants, where such antioxidants may lose their medical, pharmaceutical, and/or homeopathic potency when exposed to the UV rays, when dissolved in various fluids beyond a preset period of time, when forming precipitation in the fluids, and the like. In order to prevent or at least reduce certain oxidation reactions which take place in or on the human body, such antioxidants preferably retain at least a portion of their potency when dissolved into the fluid within a certain period of time before use or consumption. Various media may further include one or more agents which may not be the antioxidants.

Each medium may be provided with a single antioxidant or with multiple antioxidants. When the medium includes a single antioxidant, such an antioxidant may be distributed uniformly thereacross or, in the alternative, may be unevenly and preferentially distributed in its interior. In the latter case, such an antioxidant may be distributed in the symmetric or asymmetric arrangement relative to the center or other landmarks of the medium such as, e.g., a top or bottom surface of the medium, a preset edge of the medium, and the like. In addition, the single antioxidant may be distributed into multiple segregated regions which may be defined in an even or uneven arrangement across the medium as well, where such regions may then be disposed in the axial arrangement along the longitudinal axis of the medium, in the radial or concentric arrangement along a radius of the medium, in the angular arrangement about the longitudinal axis of the medium, and the like. When the medium includes multiple antioxidants, such antioxidants may be distributed or mixed uniformly across such a medium or, in the alternative, may be unevenly distributed, e.g., forming a region concentrated with one of such antioxidants. In addition, such antioxidants may be distributed in the symmetric or asymmetric arrangement with respect to the center and/or another landmark of the medium. In addition, one, some or all of such antioxidants may be distributed to form the segregated regions defining different concentrations of such antioxidants from the rest of the medium. Each region may also include only one of such agents or antioxidants or at least one of such regions may include multiple agents or antioxidants, and may be formed radially, axially or angularly. The antioxidant may be fabricated to define the gaps or macropores thereacross or therein, may be provided to define micropores, and the like. When desirable, the antioxidant may be disposed in such an arrangement to form the path for the fluid as the antioxidant dissolves in the fluid. Each medium may instead include one or multiple agents which may not be such antioxidants, where the agents may be disposed, distributed, and/or arranged similar to the antioxidants.

The medium may include at least one filler which is preferentially disposed on its exterior so as to form a coating or coat layer. Depending on its solubility, the coat layer may cover the entire portion (or only a portion) of the interior of the medium. Thus, the coat layer may first dissolve into the fluid to expose the antioxidant distributed in the interior of the medium to the fluid. Alternatively, the coat layer may define multiple regions dissolving into the fluid in different rates, thereby controlling the dissolution rate of the antioxidant. In another alternative, such a coat layer may form one or more outer openings through which the fluid contacts and dissolves the antioxidant disposed in the interior of the medium, whereby the medium controls the dissolution of the antioxidant. When desirable, the medium may also include multiple coat layers which may be disposed concentrically and one over the other, where the layers may also define identical or different thicknesses, may include identical or different fillers, and the like. When desirable, one or multiple layers of the antioxidants may also be incorporated between the coat layers, thereby manipulating the dissolution pattern of the antioxidants. Alternatively, multiple coat layers may be disposed angularly (i.e., about the longitudinal axis of the cylindrical medium or the radius of the spherical medium) or axially so as to manipulate the dissolution pattern of the antioxidant while dissolving such simultaneously or sequentially. In short, the coat layer may provide protection against the UV rays, protection against the dissolution, and the like. In addition, the coat layer may be made of and/or include substances which are capable of preventing sticking between multiple media during storage.

Such a medium may also include one or multiple fillers which may perform various functions as described above. Such a filler may be made of and/or include a substance insoluble to the fluid, only partially soluble thereto or readily soluble thereto, where selection of the suitable solubility of the filler may depend on various factors such as, e.g., an intended function of the filler, a location of the filler, a disposition of the filler, an arrangement between the filler and antioxidant, and the like. Therefore, the insoluble or partially soluble filler may be employed to block the UV rays from the antioxidant, to retain the antioxidant thereon or thereover, to maintain the shape and size of the medium during and/or after the dissolution of the antioxidant, to define the gaps or macropores for the fluid and/or antioxidant and to maintain such paths for the fluid during and/or after the dissolution, to maintain the density of such a medium during and/or after the dissolution, and the like. To the contrary, the soluble filler may be used to protect the antioxidant from the UV rays only before the dissolution but not during and/or after such dissolution, to retain and/or cover the antioxidant thereon or thereover before the dissolution but to be dissolved into the fluid along with the antioxidant thereafter, to change the configuration of the medium during and/or after such dissolution, to change the apparent density of the medium during and/or after the dissolution, to generate the gas during the dissolution, and the like.

Each medium may be provided with a single or multiple fillers along with the antioxidant. When the medium includes a single filler, the filler may be distributed uniformly thereacross with respect to the medium and/or antioxidant or, in the alternative, may be preferentially distributed in the interior of the medium. In the latter case, the filler may be disposed in the symmetric or asymmetric arrangement with respect to the center or other landmarks of the medium such as, e.g., a top or bottom surface of the medium, a preset edge of the medium, and the like. In addition, the single filler may be distributed into multiple segregated regions which may be defined in an even or uneven arrangement across the medium as well, where such regions may be disposed in the axial arrangement along the longitudinal axis of the medium, in the radial or concentric arrangement along a radius or diameter of the medium, in the angular arrangement about the longitudinal axis of the medium, and so on, where the antioxidant may be evenly or unevenly mixed with the filler. When the medium has multiple fillers, such fillers may be distributed or mixed uniformly across such a medium or, alternatively, may be unevenly distributed, e.g., forming a region concentrated with one of such antioxidants, where the antioxidant may also be mixed with the filler evenly or unevenly. In addition, such fillers may be distributed in the symmetric or asymmetric arrangement with respect to the center and/or another landmark of the medium and/or to the antioxidant. In addition, one, some or all of such fillers may be distributed to form the segregated regions defining different concentrations of such fillers from the rest of the medium. Each region may also include only one of such fillers or at least one of the regions may include multiple fillers, and may be formed radially, axially or angularly. The filler may be fabricated to define the gaps or macropores thereacross or therein, may be provided to define micropores, and the like. When desirable, the filler may be disposed in such an arrangement to form the path for the fluid as the antioxidant dissolves into the fluid. It is appreciated that the filler may form the mixture with the antioxidant in each of the above examples and that the filler may be evenly or unevenly mixed with the antioxidant in such a mixture.

As described above, the filler may be used to manipulate the apparent density of the medium. For example, the heavy fillers may be used to increase the apparent density of the medium, whereas the light fillers or the fillers defining the voids therein or therearound may be employed to decrease the apparent density thereof. Depending upon the solubility thereof, the filler may be incorporated to vary the apparent density of the medium during the dissolution. In addition, such a filler may have a density different from the antioxidant and/or fluid and may then be disposed in a preset portion of the medium in order to orient the medium along a preset arrangement, e.g., by defining the top and bottom of such a medium, and the like.

The filler may be at most partially soluble or insoluble and extend along one axis of the medium such that the medium may maintain its dimension when immersed into the fluid. Alternatively, the filler may swell and increase its dimension when mixed with the fluid, thereby maintaining the dimension of the medium after being immersed into the fluid. The filler may also be fabricated to define macropores or gaps and/or may be provided with an article with micropores. The filler may be distributed in such a pattern as to define the macroscopic and/or microscopic paths for the fluid as the filler is mixed with and dissolved into the fluid. The filler may be distributed in different regions of the medium and may be provided in different thickness and/or in different surface areas so that the segregated regions of the medium expose the antioxidant or agent disposed thereunder to the fluid in different extents, thereby mixing the agent or antioxidant in such regions in different sequences and/or in different rates. In the alternative, different fillers may be distributed in different regions of the medium so that the antioxidant or agent included in such regions may be exposed to the fluid in different extents, thereby mixing the agent or antioxidant in such regions in different sequences and/or rates. In addition, the medium may include one or more voids therein or thereacross, thereby orienting the medium in a preset direction or manipulating the apparent density of the medium.

One particle type of various fillers of the present invention is the filler which produces the gas when mixed with the fluid, where such a filler is referred to as the “gassifier” within the scope of this invention. In general, the type of the gas depends not only upon the chemical property of the gassifier but also upon that of the fluid, although there are a few requirements and/or qualifications for the gas. The first requirement is that the gas produced by the gassifier is not toxic gases examples of which may include CO, NOₓ, SOₓ, and other conventional poisonous gases. The second requirement is that the gas produced by the gassifier is not oxidizing substances examples of which may include O₂, O₃, and other conventional oxidizers. The third requirement is that such a gassifier may produce the gas when mixed with water in its pure state or in various aqueous solutions which may be partially acidic or basic. In view of the foregoing, such a gassifier may preferably produce nontoxic gases such as, e.g., CO₂, N₂, and the like.

The gassifier may be mixed with the antioxidant and/or other agents, may be distributed in the medium, and may be arranged in the medium in various arrangements similar to those of such fillers in general. Therefore, such a medium may include a single gassifier or multiple gassifiers which may be distributed across such a medium in the even or uneven arrangement, in the symmetric or asymmetric arrangement, and the like, where the gassifier may be mixed with or segregated from the antioxidant or other agents. As the medium includes multiple segregated regions, the gassifier may be distributed in one or more of such regions or in the matrix, where such segregated regions may be provided in a radial or concentric arrangement, in an axial arrangement, in an angular arrangement, and so on. The medium may include multiple gassifiers which may be mixed with each other or which may instead be segregated from each other. Each or at least one of such multiple gassifiers may further be evenly or unevenly distributed in or across the medium, symmetrically or asymmetrically arranged across such a medium, and the like. The gassifier may be distributed in the medium in order to produce the preferred movement of the medium when immersed with the fluid. For example, the gassifier may be disposed in one portion of the medium such that, when immersed into the fluid, the medium may be propelled by the gas generated by the gassifier and move in the direction which is opposite to a position of such a portion of the medium. Conversely, the gassifier may be arranged to move the fluid therearound so as to prevent and/or reduce formation of the concentration boundary layer around the medium, thereby promoting the dissolution and subsequent mixing of the agent (or antioxidant) and/or filler in the fluid.

Although any of gas-generating mechanisms may be employed in this invention, it is generally preferred that the reactants generate the gas when exposed to or mixed with various fluids including water. Accordingly, a solid (or powder) gassifier may generate the gas when exposed to the fluid, a solid (or powder) gassifier may generate the gas when mixed with aqueous solutions, and/or when a liquid gassifier is mixed with water or other aqueous solutions, and so on.

Any nontoxic gas may be employed to produce the gas, although carbon dioxide (CO₂) seems by far the most preferred for such a purpose. Carbon dioxide may be relatively readily released from a variety of chemical compounds which include carbonate groups therein. For example, CO₂ may be obtained by reacting a sodium bicarbonate with a weak acid according to a reaction:

NaHCO₃+weak acid->Na-salt+CO₂+(water)

Other materials including therein at least one carbon dioxide-derivatives such as, e.g., CO₂, CO₃⁻² and HCO₃⁻¹, may be used as the reactive compounds to react with acids, bases, and/or other compounds so as to generate carbon dioxide through various chemical reactions, examples of which may include, but not be limited to:

neutral compound with CO₂-derivative+water->CO₂+byproduct(s)

neutral compound with CO₂-derivative+strong or weak acid->CO₂+byproduct(s)

neutral compound with CO₂-derivative+strong or weak base->CO₂+byproduct(s)

acid with CO₂-derivative+water->CO₂+byproduct(s)

acid with CO₂-derivative+strong or weak acid->CO₂+byproduct(s)

acid with CO₂-derivative+strong or weak base->CO₂+byproduct(s)

base with CO₂-derivative+water->CO₂+byproduct(s)

base with CO₂-derivative+strong or weak acid->CO₂+byproduct(s)

base with CO₂-derivative+strong or weak base->CO₂+byproduct(s)

salt with CO₂-derivative+water->CO₂+byproduct(s)

salt with CO₂-derivative+strong or weak acid->CO₂+byproduct(s)

salt with CO₂-derivative+strong or weak base->CO₂+byproduct(s)

acid with CO₂-derivative+base with CO₂-derivative->CO₂+byproduct(s)

It is appreciated that CO₂ may be obtained by other chemical reactions from other materials which may include carbon and oxygen molecules. Details of such CO₂-derivatives and other materials capable of generating CO₂, and various chemical reactions thereof are available in high-school and college-level chemistry textbooks and references.

Other nontoxic gases may also be employed to drive water from the gas-powered water guns of the present invention, where examples of such gases may include, but not be limited to, N₂, He, H₂, and the like. It is appreciated, however, that hydrogen may pose a safety hazard of explosion, though it may be readily obtained through various chemical reactions. In addition, helium may not be obtained readily by conventional chemical reactions.

When the gas-generating chemical reaction requires multiple reactive compounds, the gassifier is generally arranged to include each compound in a ratio determined by a reaction stoichiometry such that at least a substantial portion of each compound is to be consumed when the chemical reaction is to be completed and that at most a negligible portion of such reactants is to remain in the medium. For example, each gassifier has multiple reactive compounds, where each compound may be included in different axial, angular or radial regions each of which is homogeneously composed by one of such reactive compounds. In the alternative, such a reactant may be composed of multiple reactants each dose of which may consist of, e.g., multiple pellets, capsules having the reactive compound(s), liquid samples, and so on. In contrary, such a reaction stoichiometry may be used to control the rates of gas generation. For example, the solid, powder or liquid reactant may be arranged such that one or more of such multiple reactive compounds may be provided in an amount less than what is dictated by the reaction stoichiometry. Accordingly, the gas-generating reaction may be limited by a concentration of the compound with a limited supply. By providing the lacking compound as a separate solid, powder or liquid reactant, the rate and/or extent of the gas-generating reaction may be controller.

Such agents (including antioxidants) and/or fillers are generally provided in the solid state and form various shapes such as spheres, ellipsoids, beads, pellets, rods, particles, grains, particulates, granulates, powders, and the like. When the agents (or antioxidants) and/or fillers are provided with specific shapes, such may define gaps or macropores which may have characteristic dimensions in centimeters, millimeters, and the like. When the agents (or antioxidants) and/or fillers are not provided to have specific shapes such as the case of granulates, particulates, and powders, such may define micropores which may have characteristic dimensions in micrometers, nanometers, and the like.

The agents (or antioxidants) and/or fillers may be provided in the liquid state as well. It is to be understood, however, that at least one of the agents (or antioxidants) and fillers are to be provided in the solid state and constitute the exterior of the medium, while including the liquid substances therein. Accordingly, the agents or fillers in the liquid state typically define the shapes determined by the solid fillers or agents which form the exterior of the medium. When the agents or antioxidants are provided in the liquid state, it is appreciated that such agents or antioxidants may be dissolved in a proper fluid without affecting the potency of the agents or antioxidants. In general, the exterior of the medium may be made of the solid filler, while the interior of the medium is filled with the liquid agent or antioxidant, although the medium with the reverse arrangement may also be fabricated. The agent or antioxidant and/or filler may also be provided as microcapsules, where the exterior of the capsules is made of the fillers in the solid state, whereas the interior thereof is made of the agent or antioxidant in the solid or liquid state. The agent (or antioxidant) and/or filler may be provided in a suspension, emulsion, slurry, sol, gel, and the like.

As described above, the medium may define the macropores and/or micropores for promoting the mixing between the fluid and the agent (or antioxidant) and/or filler, for facilitating the dissolution of the agent (or antioxidant) and/or filler, and the like. Such pores may be provided during fabrication of the medium a priori or, in the alternative, may be provided while the agent (or antioxidant) and/or filler is dissolved into the e fluid. Similarly, the macropores or voids may also be provided to the medium so as to form the path for the fluid, to decrease the apparent density of the medium, to orient the medium along the preset direction during the dissolution, and the like.

Various media of this invention may be arranged to allow visualization of the mixing between the fluid and the agent (or antioxidant) and/or filler. In one example, the gassifier may be employed to visualize the extent of mixing and/or dissolution by an extent of gas production and distribution and/or movement of gas bubbles inside the fluid. In another example, the medium may include the agent (or antioxidant) and/or filler provided in the microcapsules. Thus, the extent of mixing and/or dissolution may be visualized by the dispersion and/or movement of such capsules on the condition that such capsules may have the color and/or diffraction index which may be different from those of the fluid. In another example, the filler may be arranged to extend from the center to the exterior of the medium, to define different colors therealong, and to be buried by the agent (or antioxidant) before dissolution so that the filler gradually exposes different colors as the agent (or antioxidant) is dissolved into the fluid.

As described herein, various fillers may serve different functions such as, e.g., providing the weight to the medium to sink such during dissolution, providing the lighter weight or void to the medium to float such during dissolution, defining and maintaining the overall shape and/or size of the medium during dissolution, defining the paths for the fluid before and/or during dissolution, protecting the agent (or antioxidant) from the UV rays, preventing a premature wetting of the agent (or antioxidant) by the fluid, preventing sticking between such agents (or antioxidants) and/or fillers during storage, defining segregated regions and/or compartments into or on which the agent (or antioxidant) is loaded to form the medium, forming the macropores or gaps before and/or during dissolution, manipulating the weight distribution of the medium for orienting the medium in the preset direction during immersion in the fluid, and so on. A few fillers, however, may deserve further attention. The first is such a filler capable of preventing sticking of the agent (or antioxidant) by forming layers between the particles of the agent (or antioxidant) which may stick to each other otherwise. Another is the filler which is distributed in such an arrangement that the medium first sinks into the fluid during an initial phase of dissolution and that the medium gradually floats in the fluid during a middle and/or final phase thereof. Such a change in the apparent density of the medium may be embodied by various modes, e.g., by incorporating the heavy agent (or antioxidant) which may reduce the apparent density of the medium as the antioxidant (or agent) dissolves into the fluid, by including the heavy filler which may reduce the apparent density of the medium as the filler dissolves into the fluid or breaks away from the medium, and the like. It is to be appreciated that the converse may be provided as well, where the medium floats in the fluid during the initial phase of dissolution and then sinks into the fluid during the middle and/or final phase thereof. Such a change in the apparent density of the medium may also be embodied, e.g., by incorporating the light agent (or antioxidant) which may increase the apparent density of the medium as the antioxidant (or fluid) dissolves into the fluid, by including the light filler which may increase the apparent density of the medium when the filler dissolves into the fluid or breaks away from the medium, by forming one or multiple voids which initially form parts of the medium but which are subsequently destroyed as walls defining such voids dissolve into the fluid and which coalesce into the fluid.

The above retainers may be provided in various shapes and/or sizes. In general, the retainers form meshes, screens, and/or nets each defining multiple openings therethrough. Such openings may define the same size or different sizes as well. In the latter case, such openings with different sizes may be disposed in various arrangements. As far as the retainer may contain the medium therein and the fluid and/or agent (or antioxidant) may flow through the openings, such a retainer may be formed in almost any shapes and sizes. The retainer may be made of and/or include various materials such as plastics, metals, woods, ceramics, and/or composite materials thereof. The retainer may be made of and/or include the heavy or light material to manipulate the apparent density of the entire medium (including the retainer) as well. Such a retainer may also be arranged to manipulate the apparent density of the medium as a whole so that the retainer may sink or float into the fluid throughout the dissolution, may sink first and then float into the fluid along with the medium therein, may float first and then sink into the fluid, and the like. The retainer may define the void therein or may attach the void thereon to manipulate the apparent density of the medium. In addition, the retainer may have a preset weight distribution so as to define a top and a bottom when immersed into the fluid along with the medium.

When the retainer is made of and/or include the substance insoluble into the fluid, the retainer may maintain its shape and size during the dissolution. In the alternative, the retainer may be made of and/or include the substance soluble in the fluid and then gradually dissolves in the fluid along with the agent (or antioxidant). The medium may be fixedly attached to a preset portion of the interior of such a retainer so that the medium stays in the portion during the dissolution. Conversely, the medium may be freely disposed inside the retainer, where such a medium freely move within the medium during the dissolution.

It is appreciated that various chemical reactions related to the dissolution of the antioxidant (or agent) and gassifier may be exothermic so that the fluid may be heated accordingly as the dissolution progresses. To the contrary, the dissolution and/or gassification reactions may be endothermic such that the fluid may be cooled gradually as the dissolution proceeds. Accordingly, such gassifiers and antioxidants (or agents) may be carefully selected in order to provide various bottled fluids which are to be heated or cooled as the agent (or antioxidant) is mixed thereinto.

The medium may further include other substances. For example, conventional surfactants and stabilizers to improve mixing characteristics of various agents (or antioxidants), particularly when the agents (or antioxidants) are at least partially hydrophobic and may not be mixed into the aqueous fluid. In addition, the medium may include various edible substances with various colors in order to visualize the mixing and/or dissolution of the agent (or antioxidant) into the fluid.

Unless otherwise specified, various features of one embodiment of one aspect of the present invention may apply interchangeably to other embodiments of the same aspect of this invention and/or embodiments of one or more of different aspects of this invention.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A medium capable of protecting at least one of its contents from ultraviolet rays and promoting mixing between said at least one of its contents and a fluid by generating gas with at least another of said contents comprising:
at least one antioxidant which tends to be degraded by said rays and which is configured to dissolve in said fluid when mixed therewith;
at least one first filler which is configured to be at least substantially opaque to said rays; and
at least one second filler which is configured to be mixed with said antioxidant and to produce gas bubbles when mixed with said fluid,
whereby said medium is capable of protecting said antioxidant from said rays by said first filler as well as promoting said mixing between said antioxidant and fluid by said gas bubbles produced by said second filler.

2. The medium of claim 1, wherein said antioxidant is configured to at least one of reduce a rate of an oxidation reaction and prevent said oxidation reaction.

3. The medium of claim 2, wherein said oxidation reaction is caused by at least one of a plurality of reactive oxygen species including at least one of a hydrogen peroxide (H₂O₂), a superoxide anion (O₂⁻), and a free radical including a hydroxyl radical (OH⁻)

4. The medium of claim 3, wherein said antioxidant is one of a natural substance and a synthetic substance, wherein said natural substance includes at least one of an α-tocopherol, a β-tocopherol, a γ-tocopherol, a δ-tocopherol, a nordihydroguaretic acid, a sesamol, and a gossypol and wherein said synthetic substance includes at least one of a butylated hydroxy-anisole, a butylated hydroxy-toluene, a propyl gallate, and a tertiary butyl hydroquinone.

5. The medium of claim 1, wherein said first filler is configured to be mixed with said antioxidant.

6. The medium of claim 1, wherein said first filler is configured to be preferentially disposed on an exterior of said medium.

7. The medium of claim 3, wherein said antioxidant is a metal chelator and includes at least one of a phosphoric acid, a citric acid, an ascorbic acid, and an ethylene diamine tetra acetate.

8. The medium of claim 1, wherein said first and second fillers are different substances.

9. The medium of claim 1, wherein said second filler is configured to produce CO₂.

10. The medium of claim 9, wherein said second filler is configured to not produce at least one of CO, O₂, NOₓ, and SOₓ.

11. The medium of claim 9, wherein said second filler is configured to include therein at least one carbon dioxide-derivative which in turn includes at least one of CO₂, CO₃⁻², and HCO₃⁻¹.

12. The medium of claim 11, wherein said second filler is a sodium bicarbonate.

13. The medium of claim 12, wherein said fluid is a weak acid.

14. The medium of claim 12, wherein said first filler is a weak acid when dissolved in said fluid.

15. The medium of claim 9, wherein said first and second fillers are the same substance which is configured to be disposed over said antioxidant and to form an opaque layer with a preset thickness capable of protecting said antioxidant from said rays.

16. The medium of claim 1, wherein said medium is also configured to define a plurality of regions therein at least two of which are configured to be distributed in a radial arrangement and to include said antioxidant therein, thereby sequentially generating said gas when said medium is immersed into said fluid.

17. The medium of claim 1, wherein said second filler is disposed in an asymmetric arrangement in said medium and to generate movement of said medium in said fluid when immersed in said fluid due to said arrangement, thereby promoting said mixing.

18. A medium capable of dissolving at least one of its contents in a fluid comprising:
at least one antioxidant which tends to be degraded by said rays and which is configured to dissolve in said fluid when mixed therewith; and
at least one retainer which is configured to be formed as an article separate from said medium, to enclose said medium therein, and to define a plurality of openings for allowing said antioxidant and fluid to move thereacross,
wherein said openings are configured to prevent particles of a preset dimension from moving thereacross, thereby containing debris from said medium inside said retainer during said dissolving.

19. A method of protecting at least one content of a medium from ultraviolet rays before dissolving said content into a fluid while promoting mixing between said content and fluid during said dissolving comprising the steps of:
providing at least one antioxidant which tends to degrade by said rays when exposed thereto;
providing at least one filler which is at least partially opaque to said rays and which is capable of generating gas when mixed with said fluid;
making a mixture of said antioxidant and filler; and
forming said medium from said mixture, thereby protecting said antioxidant from said rays until said dissolving and promoting said mixing by moving at least one of said medium and fluid through said generating during said dissolving.

20. The method of claim 19, said providing said antioxidant including at least one of the steps of:
including inside said medium at least one of an α-tocopherol, a β-tocopherol, a γ-tocopherol, a δ-tocopherol, a nordihydroguaretic acid, a sesamol, and a gossypol;
including inside said medium at least one of a butylated hydroxy-anisole, a butylated hydroxy-toluene, a propyl gallate, and a tertiary butyl hydroquinone; and
including inside said medium at least one of a phosphoric acid, a citric acid, an ascorbic acid, and an ethylene diamine tetra acetate.
